(19) United States
(12) Patent Application Publication
(10) Pub. No.: US 2026/0299904 A1
(43) Pub. Date: Oct. 1, 2026

(54) COMPILER-AUTOMATED COLLECTION ELEMENT ADDRESS COMPRESSION AND ACCESS

(71) Applicant: Zoho Corporation Private Limited, Kanchipuram District (IN)

(72) Inventors: Sridhar Vembu, Tenkasi (IN); Akshhayaa S, Guduvanchery (IN); Vivekanand S V, Dindigul (IN); Surya Prakash A, Surandai (IN); Raghul Senthilkumar, Coimbatore (IN); Subathra Periakaruppan, Madurai (IN); Sudheer A. Grandhi, Pleasanton, CA (US)

(73) Assignee: Zoho Corporation Private Limited, Kanchipuram District (IN)

(21) Appl. No.: 19/460,083

(22) Filed: Jan. 26, 2026

Related U.S. Application Data
(60) Provisional application No. 63/803,037, filed on May 9, 2025.

(30) Foreign Application Priority Data
Mar. 24, 2025 (IN) 202541027394

(51) Int. Cl. G06F 8/41; G06F 9/30

(52) U.S. Cl. CPC G06F 8/41; G06F 9/3013

(57) ABSTRACT

A compiler automatically generates pointer-compression instructions for collections. An index size is determined to index each collection element uniquely. Index values are stored in respective segments in a register. Each can be retrieved by applying a shift value and a mask to isolate it, to access an element at runtime. Throughput is increased with repeated accesses without reloading the register. Compressing access instructions reduces memory requirements and reduces cache misses. In one model, a mapping table for the collection includes physical addresses for each element. In another, the collection is instantiated such that its elements have physical memory addresses aligned with a scaling factor to allow direct access with an appropriately scaled index. Instructions to pack pointers into values for loading in an offset register are compiler-generated, as well as instructions necessary for pointer selection and memory access. Dynamic updating of models are supported: changes in number and/or size of elements result in corresponding changes to index size and number of segments during runtime. With the compiled executable, pointer compression is performed at runtime automatically and accurately without intervention in source code by a programmer.

### CROSS REFERENCE TO RELATED APPLICATIONS

This application is related to Indian Provisional Application 20/254,1027394 filed 24 Mar. 2025, and U.S. Provisional Application 63/803,037, filed 9 May 2025, both entitled “COMPILER-AUTOMATED COLLECTION ELEMENT ADDRESS COMPRESSION AND ACCESS”, both incorporated herein by reference.

### FIELD OF THE INVENTION

Embodiments of the present disclosure are related, in general, to computer programming languages and more particularly, but not exclusively, to memory management.

### BRIEF DESCRIPTION OF THE DRAWINGS

The subject matter disclosed is illustrated by way of example, and not by way of limitation, in the figures of the accompanying drawings and in which like reference numerals refer to similar elements and in which:

FIG. 1A is a computational device 100, which comprises a compiler to perform automated pointer compression.

FIG. 1B illustrates executable code 160 loaded into a memory 150 to perform pointer compression at runtime using a mapping table.

FIG. 1C illustrates executable code 160 loaded into a memory 150 to perform pointer compression at runtime with direct addressing.

FIG. 1D shows three example data structures 180 which illustrate addressable space and the effects of scaling factor selection.

FIG. 2 is a flowchart 200 illustrating an example method of compiler-automated pointer compression addressing.

FIG. 3 is a flowchart 230 illustrating an example process for emitting mapped code.

FIG. 4 is a flowchart 235 illustrating an example process for emitting direct code.

FIG. 5A is a flowchart 245 illustrating an example process for emitting dynamic updating code for a pointer-compression model.

FIG. 5B is a flowchart 535 illustrating an example process for inclusion in a pointer-compression update event handler.

FIG. 5C is a flowchart 502 showing an embodiment of determining the Unit Addressable Space (UAS), as well as associated parameters, for a direct model.

FIG. 5D is an alternate flowchart 535 illustrating modifications to the event handler for direct model dynamic updating.

FIG. 6 is an example pointer compression processing phase 640.

FIG. 7 is a flowchart 700 illustrating pointer compression processing in three phases: the Analysis Phase 710, the Decision and Instruction Generation Phase 720, and the Code Injection Phase 740.

FIG. 8 is a portion of CPU 190 illustrating various aspects of Examples 1 and 2, and the utility of their indicative G3 utility instructions.

FIG. 9 illustrates compiler 130 processing source code 110 to generate runtime dynamically-updating pointer-compression.

FIG. 10 illustrates an example embodiment of distributed Integrated Development Environment (IDE) 1000 including components of a computational device 100.

### DETAILED DESCRIPTION

In modern computing systems, memory efficiency is a critical consideration, particularly in environments where resources are limited, such as embedded systems, mobile devices, and systems with constrained hardware. Even in relatively unconstrained systems, which may include large memory, multiple processor cores, and multiple cache levels for each, performance is generally enhanced when processor-intensive tasks can be performed while utilizing the fastest cache, typically the smallest, with as few cache misses as possible. A common element in these systems is the use of pointers to reference memory addresses. Pointers, typically 32 or 64 bits in size depending on the architecture, are used to direct operations to specific locations in memory. However, in many cases, the full range of these pointers is not necessary, and much of the allocated memory is wasted due to unused bits in the pointer representation. This inefficiency becomes significant when dealing with large datasets, complex data structures, or numerous pointers within a system, leading to unnecessary consumption of valuable memory resources.

Pointer compression is a technique used to reduce the size of pointers without compromising the functionality of memory access. This method involves compressing the pointer by removing or encoding portions of the address that are redundant or unnecessary, such as bits that remain constant due to memory alignment or other system constraints. One pointer compression strategy involves leveraging the fact that memory is often aligned to specific boundaries. In many systems, memory addresses are aligned on 4-byte, 8-byte, or even larger boundaries, meaning that the lower-order bits of a pointer are always zero. These zero bits provide no additional information and can be safely removed from the pointer, reducing its size. Other methods of pointer compression include storing pointers as offsets relative to a base address, which is particularly effective when multiple pointers reference memory locations within a defined range. By compressing the pointer, significant memory savings can be achieved, which is especially beneficial in systems with limited memory resources.

Pointer compression done manually by developers in low-level programming languages like C or assembly is less common in modern programming, as the complexity it introduces includes risks which can outweigh the benefits. It can make code harder to understand, maintain, and debug. As pointer sizes and alignment can vary across different architectures, portability issues can arise. As with other manual programming tasks, the potential for bugs, often subtle and hard to diagnose, come with incorrect assumptions about pointer sizes, alignment, etc., as well as the generally higher level of complexity and size of data structures in modern code.

In embodiments detailed below, a compiler comprises a Pointer Compression Memory Management (PCMM) module that locates and evaluates collections of elements within source code. Collections may include data structures, including but not limited to objects. Elements that are not linked by a particular data structure may form a collection. For example, objects of a type can be a collection. Instructions are generated automatically to enable pointer compression for one or more collections at runtime, with no intervention required by a developer, facilitating efficient memory management and ease of use by developers.

An index size is determined as the number of bits required to index each element in a collection uniquely. A register is segmented into a plurality of segments of the index size, and one or more index values are stored in respective segments in the register. The number of index values that can be stored in one register is the register size divided by the index size. Each index value can be retrieved by applying a shift value indicative of its segment's position in the register and a mask of the index size to isolate it. When a request for access to an element of the data type is encountered at runtime, the element is accessed with its associated index value, which is retrieved from the register via the corresponding shift value. Data type elements can be accessed repeatedly without requiring reloading of the register, increasing throughput. In addition, compressing access instructions reduces memory requirements in general, and also improves performance when cache misses are reduced.

Each collection may be analyzed as it relates to other constructs within the source code. Based on the type and frequency of access to elements in the collection, the compiler determines whether to enable pointer compression for the collection, and to select a pointer-compression model to employ when it so finds.

The compiler auto-generates instructions to instantiate the collection and any supporting structure at runtime. For example, with one model, a mapping table is instantiated along with the collection including physical addresses associated with and for accessing elements of the collection. In another model, the collection is instantiated at runtime such that its elements have physical memory addresses aligned with units of a scaling factor, to facilitate direct access with a pointer compression index appropriately scaled. Instructions to enable pointer-compression access to a collection are generated to support access instructions in the source code. Suitable modifications to those access instructions may be made by the compiler as necessary. Instructions to pack pointers into values for loading in an offset register are generated, as well as instructions necessary for pointer selection and subsequent memory access. Dynamic updating of models are supported, such that changes in the number of elements and size of the elements resulting from a collection update can result in corresponding changes to parameters such as pointer size and number of segments and the access model is updated during runtime. Embodiments are disclosed for auto-generating and/or injecting these instructions during compile time at differing phases of compilation. In each embodiment, with the resultant executable code, pointer compression is performed at runtime automatically and accurately without intervention in source code by a programmer.

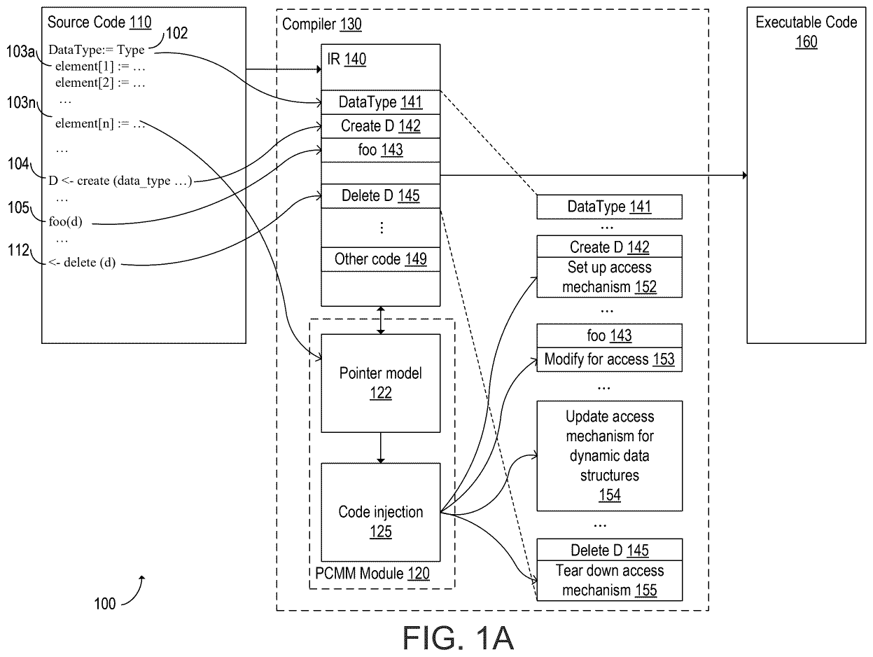

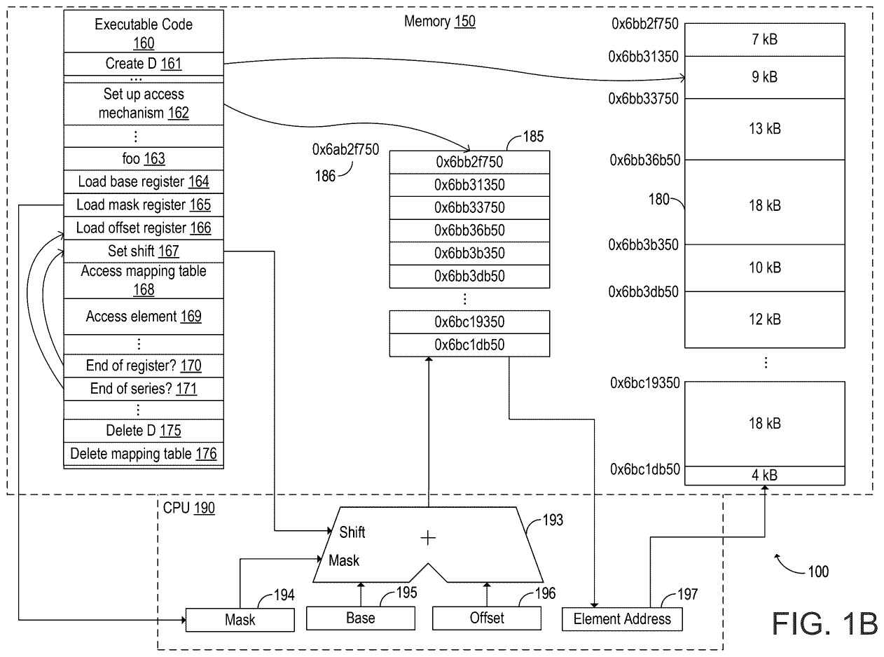

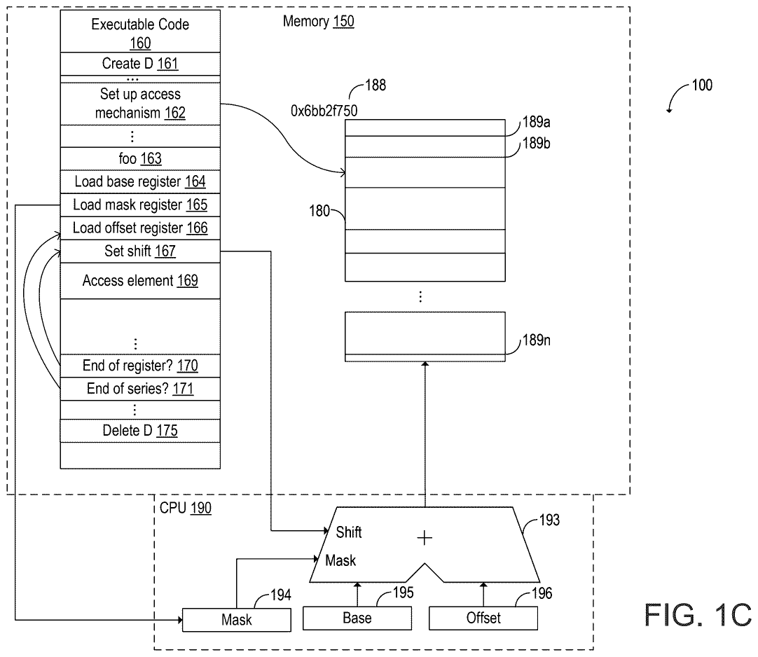

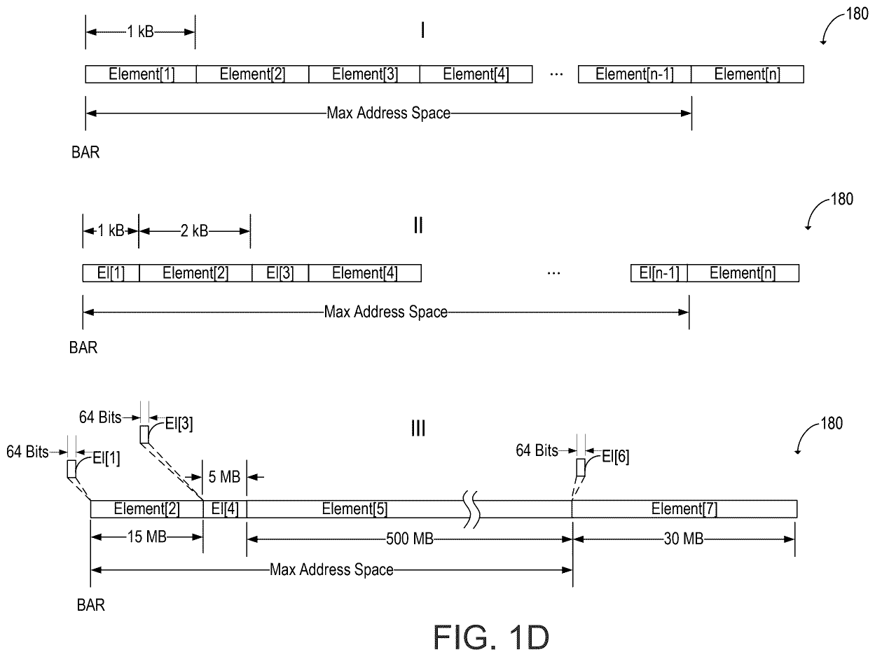

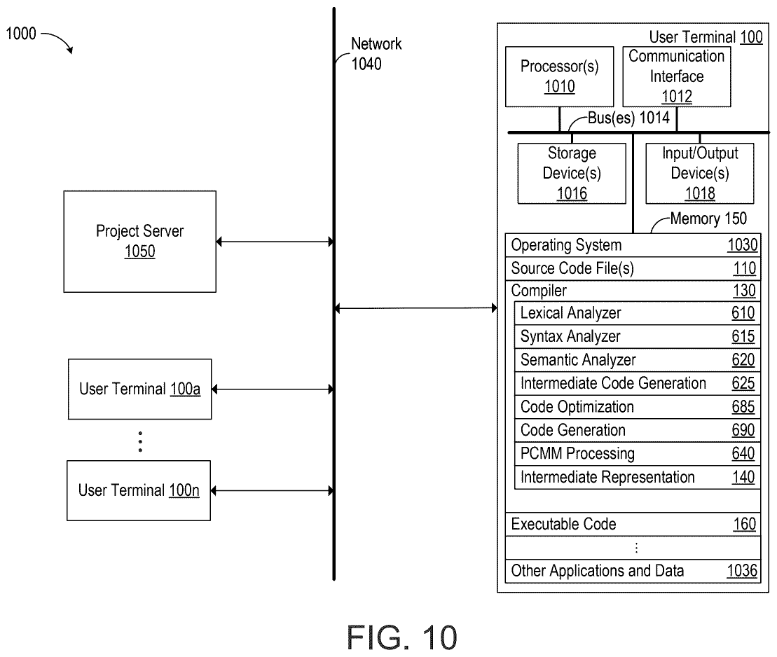

FIG. 1A depicts an example embodiment of a computational device 100, such as a computer or user terminal, detailed further below with respect to FIG. 10, which comprises a compiler 130 operable with an Intermediate Representation (IR) 140 of source code 110 to perform automated pointer compression. IR 140 can be further compiled to produce executable code 160. FIG. 1B illustrates executable code 160 loaded into a memory 150 of computational device 100 to perform pointer compression at runtime using a mapping table. FIG. 1C illustrates executable code 160 loaded into a memory 150 of computational device 100 to perform pointer compression at runtime with direct addressing.

Compiler 130 generates intermediate representation (IR) 140 from source code 110. Pointer compression memory management (PCMM) module 120 operates on IR 140, which can be any type of IR, and can operate on source code directly in an alternate embodiment. It identifies each collection and data structure in source code. For each collection or data structure, PCMM 120 utilizes pointer model selection model 122 to determine whether or not to use compression and, if so which model to deploy, and whether to enable dynamic updating. When pointer compression is enabled, code injection module 125 generates and/or modifies code to implement required structures and data structure access at runtime. In one embodiment, those instructions are introduced into IR 140. Any number of additional compiling phases may be performed on IR 140.

Source code 110 comprises an illustrative collection. In several embodiments detailed below, the illustrative collection is a data structure, in this case a data type 102 for defining a data object of type DataType. Other embodiments support collections in general, not specifically a data structure or object. Data type 102 includes N elements element [1-n] 103a-n. Create statement 104 creates object D of type DataType. DataType definition 102 is compiled into IR instructions 141. IR create instructions Create D 142 are generated from the create statement 109. Source code 110 comprises a function foo (d) 105, which compile to IR instructions 143. The function foo operates on a DataType object and will be used to illustrate access to a data structure using pointer compression. IR instructions Delete D 145 are generated from delete statement 112. All other source code 110 statements (details not shown) are generated into IR code illustrated as other code 149. All source code statements can be evaluated and analyzed for performing pointer model selection, and to modify any data structure accesses accordingly.

Code injection 125 generates instructions 152 to set up an access mechanism suitable for a selected pointer compression model, in conjunction with the creation of the data structure, an object in this example. Instructions 153 are generated to modify foo instructions 143 to enable pointer compression access of the data structure. A data structure may be defined having a static set of elements, in which case the compiler determines the pointer compression parameters and code for injection at compile time, and the appropriate data structure, access mechanism, and access modifications are prepared and initialized and performed on the data structure at runtime. Dynamic data structures are also supported, in which elements may be added or removed. If the compiler encounters a dynamic data structure, the access mechanisms to implement access are modified accordingly. In one embodiment, an event handler is created, triggered upon an update to the data structure, to determine whether the compression scheme should be modified in response to a change in the number of elements of the data structure. Data structure access instructions, such as those in foo 143 are updated to accommodate different pointer compression segment sizes. Instructions 155 are generated such that, when a data structure is deleted at runtime, the associated access mechanism can be torn down as well.

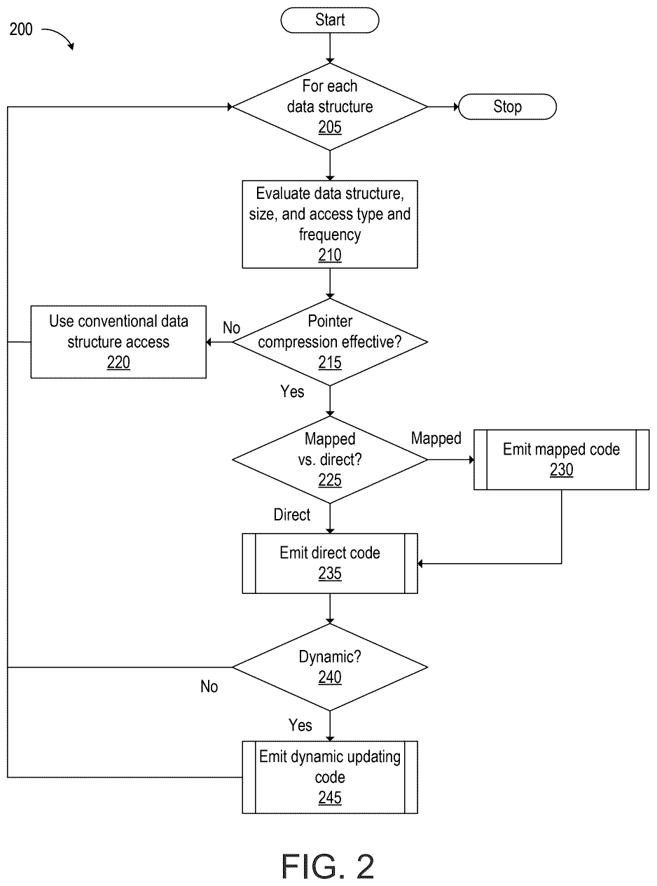

FIG. 2 is a flowchart 200 illustrating an example method of compiler-automated pointer compression addressing. The process searches for each data structure in source code (205), typically using an Abstract Syntax Tree (AST), but alternatively operating on source code directly, or any intermediate representation derived therefrom. The data structure is evaluated based on number and size of its elements, and the types and frequency of access to the data structure in other parts of the code (210). A determination is made whether pointer compression would be effective (215). If not, conventional access is selected for compiling the data structure (220). Example criteria include the number of elements not exceeding the maximum addressable space to benefit from segmentation. Another would be the expected accesses to the data structure would provide a performance improvement from pointer compression that exceeds the computational overhead in deploying it. For example, if access to a data structure of a suitable size was frequent but to only a single element at any given time, then conventional direct addressing would be selected as there would be no advantage to employ compression.

When pointer compression is determined to be effective (215), then the next determination is to choose a model. Each data structure evaluated can have a model tailored to it and need not adhere to the mechanism of any other data structure. On the other hand, the compiler may recognize that certain data structures share commonality of structure, or are often used together for processing, then the pointer compression mechanism may be designed to take advantage. For example, consider matrix operations performed on two or more matrices, where the offset addressing will be identical for accesses to the matrices, and only the base register value is used to differentiate their location. The compiler can emit code that is not only common to the two or more data structures, but address processing can be shared by them for improved performance.

While there are myriad variations and combinations available, two general types are detailed for illustration: mapped and direct. Mapped pointer compression utilizes a mapping table comprising physical memory addresses for each data structure element indexed by a compression pointer. The size of the pointer is dictated solely by the number of elements in the data structure. The mapping table can address an element of any size. An element access thus requires an access to the mapping table, followed by an access to the data element with the address returned from the mapping table.

The direct pointer compression method uses a scaled pointer added to a base address to address physical memory. The pointer size is a function of the addressable memory spanned by the elements as well as the scaling factor. As such, when the size between the largest and smallest element increases, the pointer size increases relative to a comparable mapped pointer method. The pointer size can be reduced by increasing the scale factor, which correspondingly increases the memory required by the smaller elements. The compiler can assess the model to select based on the data structure itself, and how it is used. User-defined parameters can be supplied to direct a particular compilation to favor memory allocation to processor performance, or vice versa.

When a mapped model is selected (225), the compiler emits mapped code (230). When a direct model is selected, the compiler emits direct code (235). Illustrations are provided below, along with optional modifications. In either model, an index size is selected as the number of bits required to index each of the data structure elements uniquely. Instructions are then emitted to implement the model at runtime, which instantiate the data structure in memory and provide the mechanism to access the data structure. A data structure element is accessed in the memory with an index value stored in one of a plurality of segments in a register, either via a mapping table or directly. The index value is selected by a shift value identifying the segment and a mask is used to extract it. The user develops source code using data structure access constructs native to the source code. The compiler automatically injects additional instructions to implement access elements according to the selected model.

During the analysis phase, the compiler may identify accesses to the data structure and annotate those individually for suitability for compression, and potentially a particularly suitable compression model for that access. These annotations may be used in generating mapped code (230) or direct code (235). In some embodiments, more than one compression model may be deployed for a data structure, with different access functions utilizing different models at runtime.

Dynamic pointer compression is supported. The compiler determines (240) from the source code whether a data structure is static, having a fixed number of elements, or dynamic, allowing for elements to be added or removed (elements of varying size can also become a factor). When a data structure is dynamic, the index size can increase when the number of elements or addressable space increases above a threshold and can decrease in response to corresponding reductions. Code is emitted (245) to enable support for dynamic updating of the pointer compression model at runtime (whether mapped, direct, or another variant).

FIG. 1B depicts IR 140 having been compiled into executable code 160 and loaded into a memory 150 for runtime execution. In this example, pointer compression is performed at runtime using a mapping table. Shown operating on the instructions in executable code 160 is a portion of a Central Processing Unit (CPU) 190, an example of a processor 1010 (detailed below with respect to FIG. 10). Embodiments illustrated below will, when specified, refer to a 64-bit architecture for registers and memory word-widths. Those of skill in the art will readily adapt the principles detailed herein to any architecture size.

Instructions Create D 161 are compiled from the Create D 142 instructions, and they instantiate data structure 180 having a number of elements in memory 150 at runtime, with each element of the data structure 180 having an associated address in memory 150 (0x6bb2f750-0x6bb3db50). Instructions 162 to set up the access mechanism, compiled from instructions 152, instantiate mapping table 185, which is a list of element addresses (0x6bb2f750-0x6bb3db50) stored in memory 150 at list memory address 186.

The instructions for foo 163 are compiled from foo 143 and have been modified to account for the compression pointer model selected. In this example, foo 163 will simply access each element of data structure sequentially. The index size has been selected, and index values for each element have been packed into access constants, determined at compile time, where the number of access constants required is determined by the total number of elements divided by the number of segments, plus any residual. A series of access constants to incrementally access the data structure are compiled and stored. A mask value is determined at compile time that is sized according to the index size.

When executable code 160 is finalized, the available hardware in CPU 190 will have been considered to optimize performance. In this example, a general Arithmetic Logic Unit (ALU) 193 is available, which among other functions, allows for a simultaneous shift operation and a mask operation (bitwise AND in this example) to an input. The inputs (as shifted or masked) can also be summed. A number of registers are available. They will be referred to by their function in this example but are typically available as general-purpose registers. Offset register 196 is loaded with a value comprising pointer compression indexes, which can be a pre-compiled constant, or a variable generated in accordance with code emitted by the compiler. In this simple example, pre-compiled constants are used. A base value is loaded in base register 195. In this example, to access the mapping table 185, list memory address 186 is loaded into base register 195. For each access to the data structure, one index will be selected from the offset register 196, added to the base register, and the resultant memory address will be accessed to retrieve the associated address of the element, which will be stored in element address register 197, for subsequent use to access the data structure element, as shown.

Embodiments detailed herein can be adapted to virtually any CPU and its corresponding ALUs, including those custom-made or standardly available. A wide variety of memory access instructions, register configurations, and ALU operations may be found in any CPU. It is an inherent aspect of a modern compiler to generate target executable code for a CPU that takes advantage of available components and design, which is tailored for each application compiled and target architecture, and which the techniques detailed herein for automated data structure element address compression and access are well suited. Common architectures include the x86-64 architecture (Intel/AMD) and the ARM64 architecture. Details for available instructions, registers, and memory access protocols useful for automated pointer-compression can be found in these references:
Intel 64 and IA-32 Architectures Software Developer's Manual, Vol. 1-3, Intel Corporation, 2021. Available: www.intel.com/content/www/us/en/developer/articles/technical/intel-sdm.html
AMD64 Architecture Programmer's Manual, Vol. 1-5, Advanced Micro Devices, 2017. Available: www.amd.com/en/support/tech-docs
ARM Architecture Reference Manual, ARMv8-A for ARMv8-A architecture profile, ARM Ltd., 2020. Available: developer.arm.com/documentation/ddi0487/latest/

Returning to function foo 163, instructions to load the base register 164 are executed to place the list memory address in the base register 195. A suitable mask for the pointer compression model is stored (165) in mask register 194. Offset register 196 is loaded with the first access constant in the series of access constants (166). To select an index, a shift value is set (167) which applies the appropriate shift value to ALU 193. The mask value from mask register 194 is selected for mask operation in ALU 193. The shift and mask are performed on the input receiving the offset register 196, and the shifted masked result is added to base register 195. The mapping table 185 is accessed (168) with ALU output and the element associated address retrieved is stored in element address register 197. The data structure element is accessed (169) from the memory 150 with the retrieved associated address 197.

The process repeats, updating the shift value to access the next pointer index (jump to 167), until the end of the register is reached (170), e.g. all the index values in the segments of the offset register 196 have been used. If the series of constants is not finished (171) jump to load the next access constant (166), and loop through the segments to access the next pointers in the offset register. When the series of register values is exhausted (171) foo is complete, and runtime execution continues.

At some point, delete D instructions (compiled from delete D 145) are executed (175), and the data structure 180 is deleted from memory 150. Consequently, the mapping table 185 is no longer needed and is deleted (176) from memory as well (compiled from access mechanism tear down instructions 155).

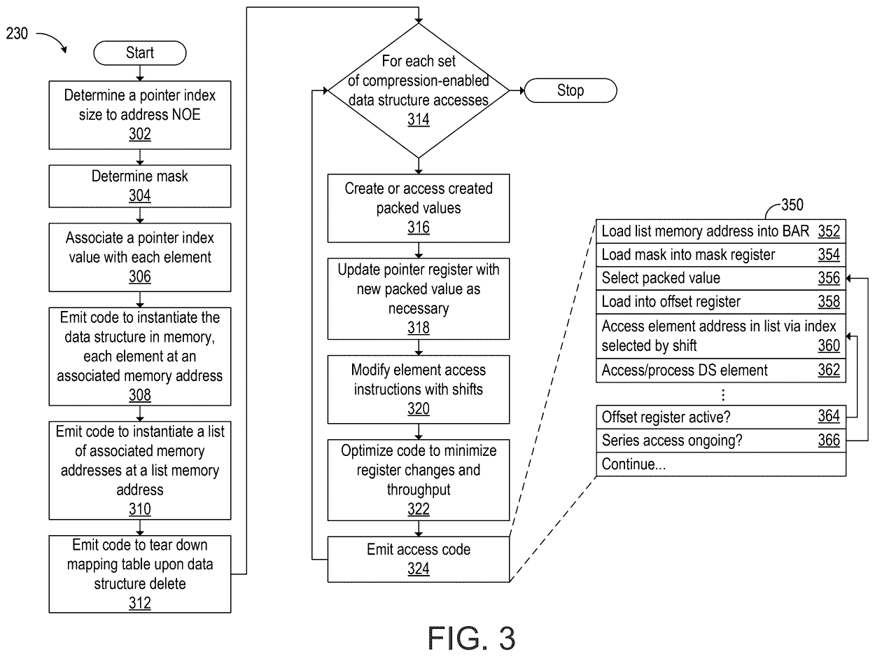

FIG. 3 is a flowchart 230 illustrating an example process for emitting mapped code 230 of FIG. 2. A pointer index size is determined such that the Number of Elements (NOE) of the data structure can be addressed uniquely (302). A corresponding mask is determined (304), sized to extract a pointer index during runtime. In examples illustrated further below, the mask is generated such that the extracted pointer index will be word-aligned for accessing the memory (after adding to the base address register, as detailed above). A pointer index is associated with each element in the data structure (306). Code is emitted to instantiate the data structure in memory, where each element of the data structure is located at an associated memory address (308). Code is emitted to instantiate a list of the associated memory addresses at a list memory address (310). Code is emitted (312) to tear down the mapping table (e.g. list of associated memory addresses) upon deletion of the data structure, as it is no longer required for access.

The compiler then proceeds to process pointer-compressed access to the data structure. For each set of compression-enabled data structure accesses (314) steps 316-324 are carried out. When all the accesses are processed the process stops. The compiler may perform an analysis of each access and those surrounding it to determine sets of accesses that are amenable to pointer compression. Alternatively, or additionally, as introduced earlier, the compiler, during earlier phases of compiling, may have annotated certain accesses as candidates for compression, and others to utilize conventional access.

The compiler may create packed values or access those already created (316). Packed values comprise one or more pointer indexes for accessing the data structure. Any process for creating the packed values may be employed and are compatible with the techniques for automatic pointer-compression processing for access. Depending on the segment size and the number of elements, a data structure may be addressable by a single packed value on one extreme, or many packed values may be required for completely accessing all elements. The compiler can create as many packed values as required to optimize memory requirements and throughput. For example, an element's pointer index may be found in many packed values, where the other pointer values packed with it are deemed to be more likely to be accessed concurrently with the pointer based on context within the code. The compiler may reorder instructions so that the indexes in a packed value are used as many times as possible when multiple accesses occur to a set of locations in a data structure. From one point of view, a packed value represents a micro-cache of addresses, and any cache management optimization strategies can be used by the compiler in determining packing strategies. In other embodiments, functions, procedures, and packages of those may have pointer-compression functionality designed within, so that the compiler can access that functionality as and when it determines compression, of any supported size or model, is appropriate. Such functionality is automatic and not visible to the developer in a fully automated embodiment.

The compiler then modifies the element access instructions from their conventional coding as provided by the developer to access from a packed value, to be loaded in an offset register at runtime, according to a shift (318). The compiler will also update the pointer register with a new packed value as necessary to carry out the access instructions being compiled (320). The compiler translates an access to an element to an access to that element's associated pointer index value. When that index value is present in the current packed value, access is achieved by providing the appropriate shift value to select it. When it is not, a new packed value containing the index value is loaded, and then the pointer index access instruction can be subsequently inserted. The compiler can perform various code optimizations to minimize register changes and maximize throughput (322). The modified and augmented access code for the set of accesses is emitted. Again, the process is performed for as many sets of accesses are available and susceptible to effective pointer-compression access.

An example set of access code instructions 350 are illustrated, which are similar to the example described in FIG. 1B above. These will be compiled into machine code that preforms the set of accesses at runtime. In this example, the compiler has determined that the CPU needs to be initialized to access the data structure. As such, the list memory address for the data structure is loaded into a base address register (352). The mask determined in 304 is loaded into the mask register. Then the series of accesses to the data structure can commence. A packed value is selected (356) and loaded into the offset register (358). The access instruction provides the appropriate shift value for the desired element index, which is added to the BAR, and the mapping table is accessed, which will return the element's physical address in memory (360). The data structure element is then accessed and processed according to any function-specific instructions (details not shown). While the offset register is active, meaning that it contains the index required for the next access, the process continues to access any element available in the offset register (364). When the offset register no longer contains the required index, if the series access is ongoing (366), the process jumps back to 356 to select and load a new packed value. Otherwise, the access instructions are complete, and execution continues.

FIG. 1C depicts an example of pointer compression being performed at runtime using direct access. The instructions are compiled from the respective AST instructions as detailed with respect to FIG. 1B. In this example, no mapping table 185 is deployed. Instead, when create D 161 (foo) instructions call for the creation of data structure 180, the access mechanism instructions 163 cause the data structure to be created with a predetermined structure to allow for direct pointer compression access. The base address 188 of data structure 180 is shown (0x6bb2f750). The first element will be loaded at that address. Subsequent elements will be loaded at offsets from the base, identified as 189a-n. The size of those offsets will be determined during compile time, and various tradeoffs can be considered by the compiler, discussed further below.

Function foo 163 executes in similar fashion as described above, with the following differences. The base register 195 is loaded (164) with the base address 188, since this is direct access, and no mapping table is deployed. The appropriate mask is loaded (165) into mask register 194, which may differ from a mask generated for mapped access. Firstly, the index size for the same NOE may be greater in direct access than in mapped access. Secondly, in mapped access the mask was shifted to word align with entries in the mapping table. In direct access, additional shifting may be employed to accommodate the scaling factor. In a general case, a scaling factor can be generated and used to multiply the index, using any multiplication method available. In examples which follow, the well-known method of multiplying by powers of 2 via shifting is used, to implement various scaling factors, although shifting to multiply is not a requirement. The offset register 196 is loaded (166) and the appropriate shift is applied to select the desired pointer index, and as just described, to multiply by the scaling factor and word align with the data structure elements in memory. There is no access to a mapping table, but memory 150 is accessed directly with the address determined as the output of ALU 193 which is the sum of the base register 195 and the masked, shifted offset register 196. Accesses proceed by jumping (170) to set a new shift value (167) until the register no longer contains the required indices (170). It the series of accesses is ongoing, jump (171) to load offset register 166 with a new packed value and continue. When the series is complete (171), execution continues. Eventually, when delete D 175 instructions are encountered the data structure is deleted from memory. Again, there is no mapping table, so no additional steps are required to tear down access.

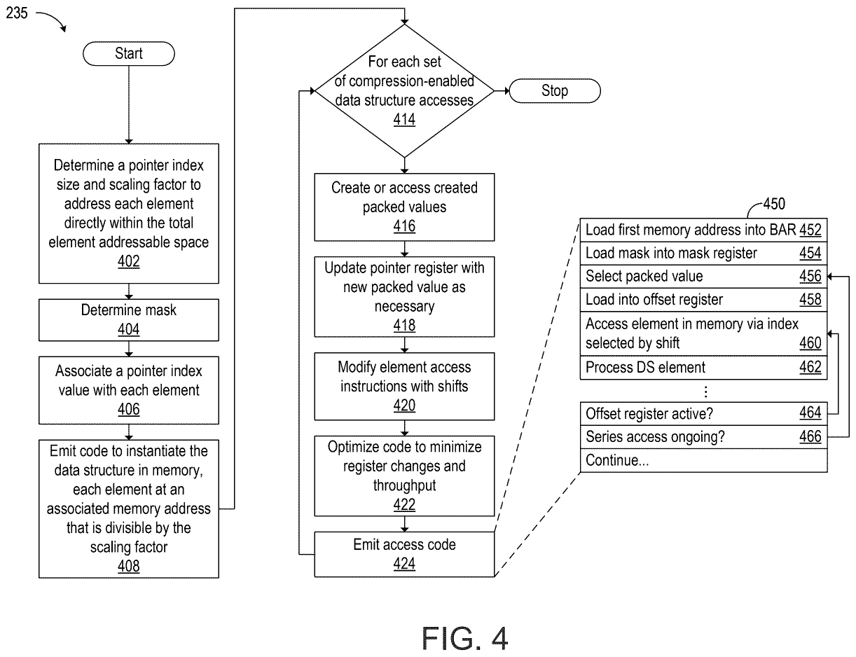

FIG. 4 is a flowchart 235 illustrating an example process for emitting direct code 235 of FIG. 2. It is similar to flowchart 230, detailed above, with some notable differences. In contrast to a mapped model, where the index size is a function of NOE, the pointer index size is determined as required to address the entire addressable space of all the elements of the data structure, which is a function of the total memory size of all the elements, and a selected scaling factor (402). As a general rule, as the scaling factor is reduced, the pointer index size increases.

FIG. 1D shows three example data structures 180 which serve to illustrate addressable space and the effects of scaling factor selection. The compiler evaluates a data structure, which for this model requires both the number of elements and their sizes. Example I shows a data structure 180 with n elements, Element[1]-Element[n]. In this special example, each element is 1 kilobyte (kB). The maximum addressable space starts at the first element (which will be populated at memory address 188 at runtime) and extends to include the starting address of Element[n]. Each elements address falls on the sum of the widths of the previous elements, with the first element starting at 0. For n elements of the same size, the final pointer address will be (n−1) size/size. The obvious choice for scaling factor in this example is 1 kB, since anything more or less would waste pointer space or memory. As such, the total addressable space is (n−1)*1 k/1 kB=n−1. There are n addresses spanning from 0 to n−1. The number of bits to address these elements is identical to the number of bits to address NOE in the mapped model.

Example II shows how changing the element sizes diverges from the mapped model addressing. In this example, odd elements are 1 kB in size, and even elements are 2 kB in size. Now the total addressable space is (n/2+2(n−1)/2)*1 kB. Again, the obvious scaling factor is 1 kb, so the number of bits selected for the pointer size is ~3n/2, or 50% greater than example I.

Example III illustrates how increasingly divergent element sizes affect the choices. In this example Element[1], Element[3], and Element[6] are 64 bits, which for pointer compression is essentially the minimum size. Element[2] is 15 MB, Element[4] is 5 MB, and Element[6] is 500 MB. Element[7] is 30 MB. The overall addressable memory required for the data structure is just over 550 MB at 576,716,992 bytes, requiring 30 bits to address with no scaling factor. Various options for scaling factor selection are illustrated in Table 1. At one extreme, if the minimum scaling factor of 64 bits is selected, the addressable space drops to 8,519,683 bytes, requiring 24 bits to address. The memory required to store the data structure is still essentially 550 MB. The maximum segments supported is 2. At the other end of the spectrum, the minimum addressable address space is found when every element takes the same size in memory, and thus the number of bits required is based solely on the NOE, as shown in example I. Here, where an address space of n−1*scaling factor=6*512 MB can be addressed with 3 bits, and therefore 21 segments are available in a register for pointer compression.

Increasing the scaling factor to reduce the index size and increase the number of segments comes at a cost of increased memory allocation for smaller elements. The amount of memory required for the data structure is the scaling factor multiplied by the addressable space, plus the memory of the final element. Thus, with low scaling factors, the required memory is essentially 550 MB, while the configuration yielding minimum pointer size, at 512 MB, requires 3.1 GB for the same sized data structure.

TABLE 1
Index, Segments and Memory for Various
Scaling Factors for Example III

| Scaling Factor | | Address Space | Index Size | Segments | Total Memory |
|---|---|---|---|---|---|
| 64 | bits | 8,519,683 | 24 | 2 | 550 MB |
| 512 | bits | 1,064,963 | 21 | 3 | 550 MB |
| 16 | kB | 33,283 | 16 | 4 | 550 MB |
| 256 | kB | 2,083 | 12 | 5 | 551 MB |
| 1 | MB | 523 | 10 | 6 | 553 MB |
| 2 | MB | 264 | 9 | 7 | 558 MB |
| 4 | MB | 134 | 8 | 8 | 566 MB |
| 8 | MB | 69 | 7 | 9 | 582 MB |
| 16 | MB | 37 | 6 | 10 | 622 MB |
| 32 | MB | 21 | 5 | 12 | 502 MB |
| 64 | MB | 13 | 4 | 16 | 862 MB |
| 128 | MB | 9 | 4 | 16 | 1182 MB |
| 256 | MB | 7 | 3 | 21 | 1792 MB |
| 512 | MB | 6 | 3 | 21 | 3102 MB |

Note that here, since all that is needed is the starting address of Element[7], the overall addressable space could be reduced by essentially 30 MB. Because Element[5] is so much larger, this won't affect the pointer size or segmentation for this example. However, if the elements were reordered, switching Element[5] with Element[7], the addressable space to access element boundaries would be reduced greatly reduced by 500 MB to just over 50 MB, which would significantly reduce the index size required to access the same sized data structure.

The element sizes were selected for this example to illustrate the effects of elements with orders of magnitude size differences. The compiler can optimize to minimize the effects of such differences, by, for example, reordering the elements and/or creating hybrid access schemes. In an alternate modification, the compiler can order the elements such that the very small ones are grouped together and conditionally compressed based on address. For example, consider an entity with 20 sets of two elements, a first of one word and a second of 1 MB. An entity represents a collection in general, e.g. a data structure, container, or other set of elements for which pointer compression is deployed. Rather than intersperse the large and small elements, the compiler can group the small ones at lower addresses, at one-word intervals, and the larger elements at higher addresses spaced apart by a scaling factor of 1 MB. The compiler can use conventional addressing to address the smaller elements, while compression for direct access to the larger. In this example, this reordering and modification reduces the memory requirement of the entity by nearly half. It is also possible for the compiler to treat the two groupings as independent entities and compression them both using different scaling factors and sets of indexes. An entity may comprise a container or be a containment of another entity. Various combinations of data structures, containers and containments are envisaged and may include mixing mapped and direct accessing schemes in various alternate embodiments. An entity may be identified as a collection of elements for which pointer-compression to access the elements is useful, such as, e.g., a collection of objects of a type.

Furthermore, an embodiment may employ non-uniform index sizes. For example, consider an object with 4 elements used with high frequency, and 32 elements used less often. A uniform index size would require an index size of 6. By breaking the object into two segments (any number of segments can be used), an index size of 2 will address the 4 high-frequency elements and an index size of 5 will address the remainder. A variety of implementations may be deployed. In this example a separate base address is used for each segment. When offset values of different sizes are packed in a packed value, the compiler can generate instructions to provide an offset selector to locate an offset value in the register as well as a size of the offset, so that offset values of differing sizes can be isolated for use in accessing a mapping table.

In another example, the mapping table will be populated such that the smaller indexes can be multiplied by a scaling factor to access the high-frequency elements. Consider an object with 16 elements. Two elements can be selected to have index values of 0 and 1, respectively. Instructions can be generated so that when a 1-bit offset value is being accessed, it is scaled. So, those two elements will, after scaling, produce an offset value of 0000 or 1000, respectively. The rest of the elements will be assigned their offset values from the 14 unused addresses within the 16-address space: 0001, 0010, . . . , 0111, 1001, 1010, . . . , 1111. Or, consider 4 elements to be mapped to index values 00, 01, 10, and 11. These can be scaled to 0000, 0100, 1000, and 1100. The rest of the elements will be assigned from the 12 unused offset values: 0001, 0010, 0011, 0101, 0110, 0111, 1001, 1010, 1011, 1101, 1110, and 1111.

Returning to FIG. 4, a corresponding mask is determined (404) sized to extract a pointer index during runtime and shifted appropriately to apply the scaling factor. Multiplying by the scaling factor (defined from a set of scaling factors that are powers of two) uses simple ALU shifts in the example embodiment, but any other method for multiplying a pointer by the scaling factor may be deployed in alternate embodiments. The mask is generated such that the extracted pointer index will be aligned for accessing the memory directly. A pointer index is associated with each element in the data structure (406). In contrast with mapped access, the pointer indices are not sequential but increase from element to element based on the size in units of scaling factor from the previous element. Therefore, in this pointer-compression model, code is emitted to instantiate the data structure in memory, where each element of the data structure is located at an associated memory address that is divisible by the scaling factor (408). Code is not required to set up or tear down a mapping table.

The compiler then proceeds to process pointer-compressed access to the data structure. For each set of compression-enabled data structure accesses (414) steps 416-424 are carried out. When all the accesses are processed the process stops. These steps are similar to 316-324 described above, except that the pointers are modified for direct access as just described (416, 418), and the shifts are calculated to both select the pointer and to scale it properly for direct access (420).

An example set of access code instructions 450 are illustrated, which are similar to the example described in FIG. 1C above. These will be compiled into machine code that preforms the set of accesses at runtime. In this example, the compiler has determined that the CPU needs to be initialized to access the data structure. As such, the first memory address of the data structure elements is loaded into a base address register (452). The mask determined in 404 is loaded into the mask register. Then the series of accesses to the data structure can commence. A packed value is selected (456) and loaded into the offset register (458). The access instruction provides the appropriate shift value for the desired element index, the scaled and masked version of which is added to the BAR, the result of which is the element's physical address in memory, so the data element is accessed (460). The data structure element is then processed according to any function-specific instructions (details not shown). While the offset register is active, meaning that it contains the index required for the next access, the process continues to access any element available in the offset register (464). When the offset register no longer contains the required index, if the series access is ongoing (466), the process jumps back to 456 to select and load a new packed value. Otherwise, the access instructions are complete, and execution continues.

Returning to FIG. 1C, the data structure detailed in FIG. 1B is adapted for access with direct mapping. Table 2 shows the addresses and sizes of each element of the data structure 180, and their addresses as implemented with mapped addressing. Elements 1-6 and 98-99 have addresses as shown in FIG. 1B. Elements 7-86 are 80 elements of 9 kB each. Elements 87-96 are 10 elements of 14 kB each. Element 97 is 6 kB. The aggregate size is listed for elements 7-97. Scaling factors ranging from 1 kB to 32 kB are shown in their respective columns. It can be seen that as the scaling factor is increased, the addressable space is reduced, requiring fewer bits to address. The index size reduces from 10 (allowing for 6 segments) to 7 (allowing for 9 segments) as the scaling factor increases from 1 kB to 32 kB. The required memory also increases as the minimum unit is increased. At 1 kB, the memory required is as small as it can be (957 kB), as every element is divisible by the scaling factor. At 32 KB, every element is the same, and the addressable space is at its minimum. However, its required memory is more than triple the minimum at 3.136 MB. Note that there is no benefit from selecting a 2 kB scaling factor as it increases memory required for the same index size. Similarly, there is no benefit to choose 32 kB over 16 kB, as, again, the memory requirement is nearly double for the same index size. The compiler can choose any of the remaining scaling factors trading off memory for number of segments. There can be user-defined parameters that give the compiler guidance as to the relative importance of memory conservation vs. other factors. The compiler can also evaluate the data structure access code to determine whether one configuration is superior to another. For example, if a process is accessing 6 or fewer elements at a time with high frequency, the compiler may decide on the lower scaling factor of 1 kB, as there is little benefit to having additional segments available. On the other hand, in a scenario where 8 accesses, or integer multiples of 8, are most frequent, then an 8 kB scaling factor may be sensible. A compiler can use any optimization techniques, including compiling and profiling with different values, etc.

TABLE 2

| Element | Address | Size | 1 kB | 2 kB | 4 kB | 8 kB | 16 kB | 32 kB |
|---|---|---|---|---|---|---|---|---|
| 1 | 0x6bb2f750 | 7168 | 7 | 8 | 8 | 8 | 16 | 32 |
| 2 | 0x6bb31350 | 9216 | 9 | 10 | 12 | 16 | 16 | 32 |
| 3 | 0x6bb33750 | 13312 | 13 | 14 | 16 | 16 | 16 | 32 |
| 4 | 0x6bb33750 | 18432 | 18 | 18 | 20 | 24 | 32 | 32 |
| 5 | 0x6bb3b350 | 10240 | 10 | 10 | 12 | 16 | 16 | 32 |
| 6 | 0x6bb3db50 | 12288 | 12 | 12 | 12 | 16 | 16 | 32 |
| 7-86 | 80 * 9 | 737280 | 720 | 80*10 | 80*12 | 80*16 | 80*16 | 80*32 |
| 87-96 | 10 * 14 | 143360 | 140 | 10*14 | 10*16 | 10*16 | 10*16 | 10*32 |
| 97 | 1 * 6 | 6144 | 6 | 6 | 8 | 8 | 16 | 32 |
| n − 1 (98) | 0x6bc19350 | 18432 | 18 | 18 | 20 | 24 | 32 | 32 |
| n (99) | 0x6bc1db50 | 4096 | 4 | 4 | 4 | 4 | 4 | 4 |
| Total | | 979,968 | 957 | 1040 | 1232 | 1572 | 1604 | 3136 |
| Addressable | | | 953 | 518 | 307 | 196 | 100 | 98 |
| Index size | | | 10 | 10 | 9 | 8 | 7 | 7 |
| Segments | | | 6 | 6 | 7 | 8 | 9 | 9 |

In the present example, the compiler has selected the 16 kB scaling factor. Table 3 shows the element sizes for each element, as well as the associated offset for each (in number of kB as well as the corresponding hex value). The offset can be added to the base address (identified in table 3 as the physical memory address of the first element) to produce the physical address for any element of the data structure, as shown. The offsets are used to pack values for associated data structure accesses, selected by shifting appropriately, and accessing the memory 150 directly at physical memory addresses 189a-n, respectively.

TABLE 3

| Element | Size (kB) | Offset (kB) | Offset | Physical Address |
|---|---|---|---|---|
| 1 | 16 | 7168 | 0x0 | 0x6bb2f750 |
| 2 | 16 | 9216 | 0x10 | 0x6bb33750 |
| 3 | 16 | 13312 | 0x20 | 0x6bb37750 |
| 4 | 32 | 18432 | 0x30 | 0x6bb3b750 |
| 5 | 16 | 10240 | 0x50 | 0x6bb43750 |
| 6 | 16 | 12288 | 0x60 | 0x6bb47750 |
| 7-86 | 1280 | 737280 | 0x70 | 0x6bb4b750 |
| 87-96 | 160 | 143360 | 0x570 | 0x6bc8b750 |
| 97 | 16 | 6144 | 0x610 | 0x6bcb3750 |
| n − 1 (98) | 32 | 18432 | 0x620 | 0x6bcb7750 |
| n (99) | 4 | 4096 | 0x640 | 0x6bcbf750 |
| Total | 1604 | | | |

Table 4 shows a variety of masks configured for different scaling factors. The base mask has a number of ones, the number equaling the pointer index size, in the least significant positions. By left shifting the mask by an appropriate value, the values that are unmasked (e.g. bitwise ANDed with the mask) are in a position that, when added to a base register, will address the memory with the appropriate scaling factor. In this example, the equivalent of left shifts are used to scale, each shift multiplying by 2, so the scaling factor, SF, is found as 2^{SF}. For example, in a 64-bit architecture, a word has 8 bytes, requiring 23 bits to address. Therefore, to address the memory on word boundaries, a 3-position shift is required, as shown. Kilobyte addressing, 2¹⁰ requires a 10-position shift. Other sample masks and shifts are illustrated as well: 9 positions for 512 bytes, 14 for 16 kB, 30 for 1 MB, and 32 for 4 MB. Note that the 1-word mask shown is suitable for use with the mapped model detailed above, as the mapping table entries are aligned on word boundaries. The 16 kB map will be selected for the direct model example.

TABLE 4
Example masks based on Scaling Factor

| Base | | 00000000 00000000 00000000 00000000 00000000 00000000 00000000 01111111 |
|---|---|---|
| Mask | | |
| 1 | word | 00000000 00000000 00000000 00000000 00000000 00000000 00000011 11111000 |
| 512 | bytes | 00000000 00000000 00000000 00000000 00000000 00000000 11111110 00000000 |
| 1 | kB | 00000000 00000000 00000000 00000000 00000000 00000001 11111100 00000000 |
| 16 | kB | 00000000 00000000 00000000 00000000 00000000 00011111 11000000 00000000 |
| 1 | MB | 00000000 00000000 00000000 00011111 11000000 00000000 00000000 00000000 |
| 4 | MB | 00000000 00000000 00000000 01111111 00000000 00000000 00000000 00000000 |

Table 5 illustrates how to align a register packed with pointer index values with a selected mask. Here the 16 kB scaling factor (SF=14) mask has been selected as shown on the first row. Each subsequent row contains 7 ones (the pointer index width) in one of the segments identified by the index j, and zeros in the rest of the positions, to highlight the location of a pointer. The position that the index needs to be moved to is illustrated by replacing two zeros with an x in the boundaries of the appropriate position, except for j=2, where the position of the pointer happens to already be in the proper position due to the combination of pointer width and scaling factor selected.

TABLE 5
Mask alignment shifting

| | |
|---|---|
| j | 00000000 00000000 00000000 00000000 00000000 00011111 11000000 00000000 |
| 0 | 00000000 00000000 00000000 00000000 00000000 000x0000 0x000000 01111111 |
| 1 | 00000000 00000000 00000000 00000000 00000000 000x0000 0x111111 10000000 |
| 2 | 00000000 00000000 00000000 00000000 00000000 00011111 11000000 00000000 |
| 3 | 00000000 00000000 00000000 00000000 00001111 111x0000 0x000000 00000000 |
| 4 | 00000000 00000000 00000000 00000111 11110000 000x0000 0x000000 00000000 |
| 5 | 00000000 00000000 00000011 11111000 00000000 000x0000 0x000000 00000000 |
| 6 | 00000000 00000001 11111100 00000000 00000000 000x0000 0x000000 00000000 |
| 7 | 00000000 11111110 00000000 00000000 00000000 000x0000 0x000000 00000000 |
| 8 | 01111111 00000000 00000000 00000000 00000000 000x0000 0x000000 00000000 |

While left shifting a value, such as a pointer index, is conceptually equivalent to multiplying by a scaling factor, any process for aligning the pointer with the mask may be deployed. Furthermore, the examples provided here can be replaced with any other sequence of shifts and masks, as well as other multiplication operations, to accomplish selecting a pointer and addressing the memory with the selected pointer. Depending on the scale factor and position of a pointer, a left or right shift may be needed to position the pointer appropriately. However, table 6 illustrates the use of a right cyclic shift, or rotate, that accomplishes the appropriate mask alignment for a pointer index in any segment j.

TABLE 6
Mask alignment shift values

| j | Bits | (RegSize − SF + j*PointerSize)% RegSize |
|---|---|---|
| 0 | 6:0 | 50%64 = 50 |
| 1 | 13:7 | 57%64 = 57 |
| 2 | 20:14 | 64%64 = 0 |
| 3 | 27:21 | 71%64 = 7 |
| 4 | 34:28 | 78%64 = 14 |
| 5 | 41:35 | 85%64 = 21 |
| 6 | 48:42 | 92%64 = 28 |
| 7 | 56:49 | 99%64 = 35 |
| 8 | 63:56 | 106%64 = 42 |

The formula to determine the shift values to select a pointer index and align it with a mask is with an index size for a (RegSize−SF+j*PointerSize) % RegSize. The shift value is used to rotate the offset register containing packed pointers to the right. In this example, RegSize is 64, the architecture size, scaling factor (SF) is 14 to align with 16 kB boundaries, and PointerSize is 7. In the illustration above, masks were generated by left shifting a base mask (at position j=0) by the scaling factor SF. This left shift is equal to right shifting by -SF, or equivalently 64-SF, since a shift by the register size puts the pointer in the exact same position. A right shift of j*7 puts the j^{th} pointer in the base position. Thus, the sum of those shifts moves any pointer from the j^{th} position to a position aligned with the mask. The modulo RegSize is helpful for illustration, but not necessary in typical ALUs in which shift values are selected from the least significant bits (6 in a 64-bit architecture), ignoring the higher bits, which automatically performs the modulo operation. The compiler may inject code to programmatically generate a shift value to select a pointer in certain functions using a formula such as this. In other instances, the location in the offset register for a pointer value is known, and so an access to a data structure element instruction will be replaced or modified by the compiler with a precomputed shift value to select the element.

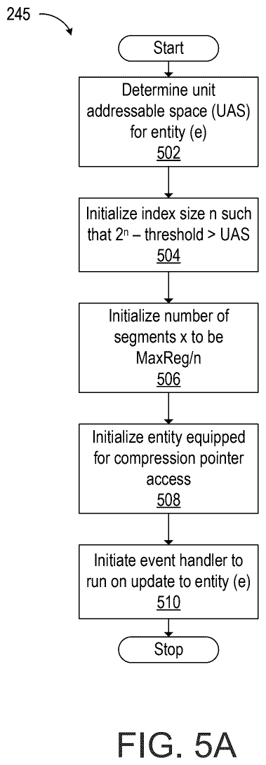

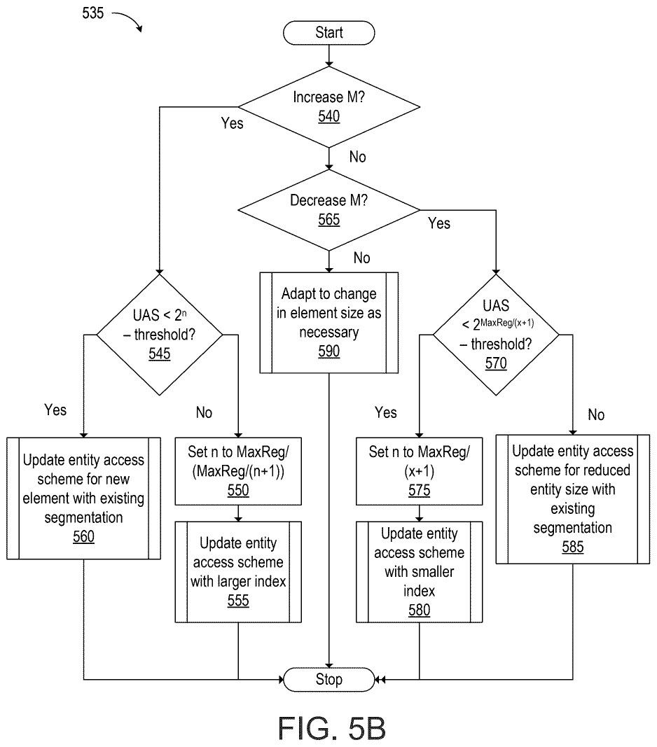

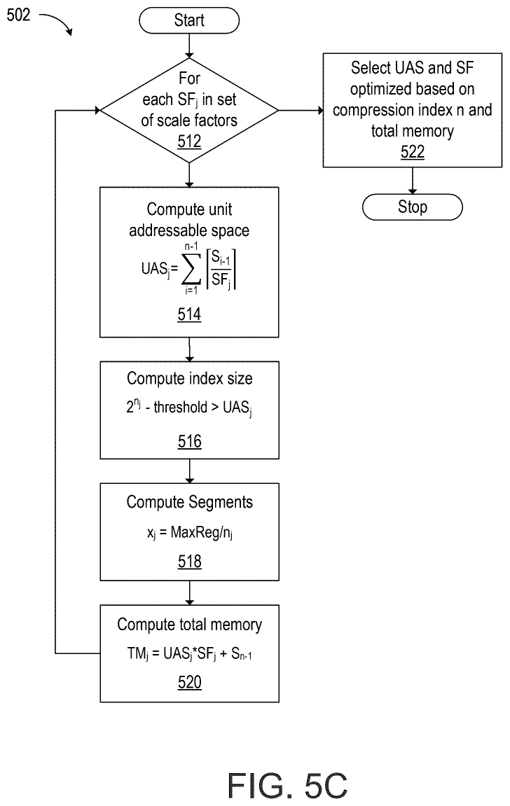

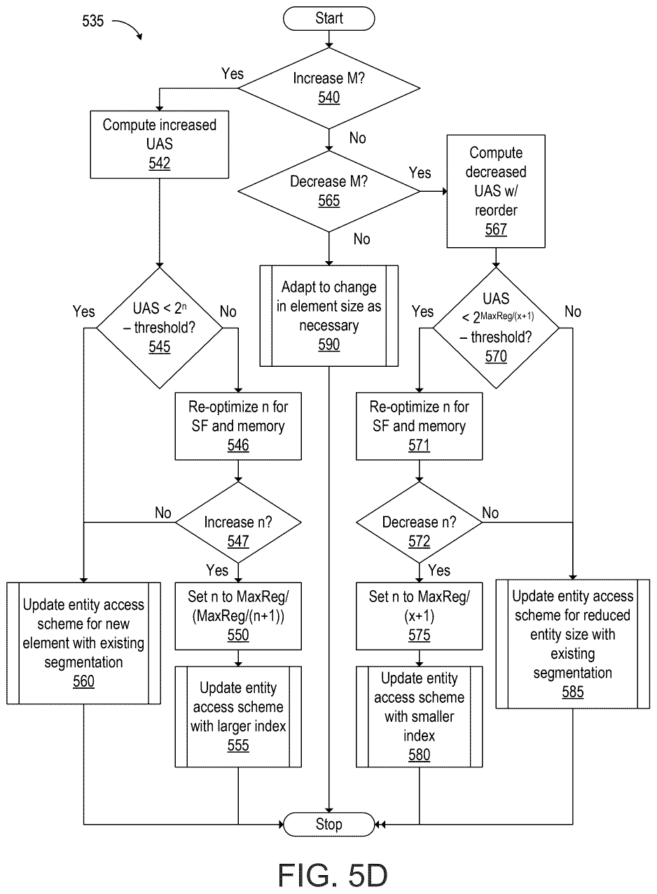

Embodiments may support dynamic model updating at runtime. As the number and/or size of elements in a dynamic data structure changes, a change in the parameters of the pointer-compression model may be introduced. Code to support dynamic runtime pointer compression is configured and emitted during compilation. FIG. 5A is a flowchart 245 illustrating an example process for emitting dynamic updating code for a pointer-compression model. It emits code that initializes the model and an event handler that includes dynamic pointer-compression instructions for execution during runtime when an update to the data structure occurs. FIG. 5B is a flowchart 535 illustrating an example process for inclusion in a pointer-compression update event handler. It illustrates how the pointer-compression model responds to an update to the data structure that changes the addressable space required. FIG. 5C is a flowchart 502 showing an embodiment of determining the Unit Addressable Space (UAS), as well as associated parameters, for a direct model. FIG. 5D is an alternate flowchart 535 illustrating modifications to the event handler for direct model dynamic updating.

In FIG. 5A, to support dynamic updating, the Unit Addressable Space (UAS) is determined for the entity (502), which in turn is used to determine the required compression parameters. The UAS for a mapped model is simply M, the number of elements, each of which has a single entry in the mapping table. The UAS for a direct model is a function of the sizes of each of the elements of entity e, and the scaling factor, as described above. An illustrative embodiment of step 502 is detailed below with respect to FIG. 5C. A pointer index size, n, is determined such that 2ⁿ is greater than UAS, and optionally by a threshold (504). 2ⁿ is the maximum UAS can be for the selected pointer size. The threshold may be predefined to provide hysteresis in changing to or returning from different states, where, in this example, different states are identified by the index size. Various thresholds may be introduced. A different threshold may be introduced for each state, and a threshold for increasing to a higher index size may differ from a threshold to decrease to a lower index size. The thresholds may be determined in any fashion to facilitate performance improvements or memory management while utilizing dynamic pointer-compression access of data structures. In the following illustration, a single threshold is referenced for simplicity. Any set of thresholds may be substituted in alternate embodiments. The number of segments, x, is initialized as MaxReg/n (506). In this example, MaxReg is the architecture size of 64 bits. Code is emitted to initialize entity e for compression pointer access (508). When a mapped model is selected for e, this code will initialize the mapping table along with the instantiation of the entity at runtime. When a direct model is deployed, no mapping table is required, but the entity will be instantiated with elements of e having memory locations aligned with multiples of the scaling factor selected. Code to initiate an event handler to run on an update to entity e at runtime is also emitted (510).

The flowchart 535 shown in FIG. 5B illustrates an example process for inclusion in the event handler. An update to an entity may not necessarily impact the compression model, but changes in the number or size of elements may need evaluation. If the update will increase M (540), then evaluate whether the increase will require an increase in the index size. If UAS will remain below 2n minus threshold (545), then update the entity access scheme for the new element with the existing segmentation (560). If UAS will increase to within the threshold of 2n (545) then the pointer size n will be increased (550). This is a general case. For mapped models, UAS is equal to M, and so the index size n must increase to accommodate the increase in M. For direct access, it is safe to increase n when the threshold is exceeded, but alternatives exist, detailed below. The pointer size can be incremented by one, which will increase the addressable space. However, some values of n will result in the same number of segments as a larger value of n with a correspondingly larger addressable space. In those instances, the largest n for the segment size is selected. This can be computed as shown (550) where n is set to MaxReg/(MaxReg/(n+1)), using integer division, or referring to the values shown in Table 7. The effectiveness of the proposed methodology becomes relevant when the number of segments is greater than one. For an index size of 33-64 bits, the system consists of a single segment, and the maximum number of addressable elements is 264, which corresponds to a conventional addressing mechanism.

TABLE 7
Pointer and segment sizes

| Index size | # of Segments | Elements Addressed |
|---|---|---|
| n | x | 2ⁿ |
| 1 | 64 | 2 |
| 2 | 32 | 4 |
| 3 | 21 | 8 |
| 4 | 16 | 16 |
| 5 | 12 | 32 |
| 6 | 10 | 64 |
| 7 | 9 | 128 |
| 8 | 8 | 256 |
| 9 | 7 | 512 |
| 10 | 6 | 1024 |
| 11-12 | 5 | 2¹² |
| 13-16 | 4 | 2¹⁶ |
| 17-21 | 3 | 2²¹ |
| 22-32 | 2 | 2³² |
| 33-64 | 1 | 2⁶⁴ |

Here it can be seen that as elements are added to the entity the pointer index size increases incrementally for values of n=1-9. When incrementing from n=10, 12 is selected. When incrementing further, the n values selected are 16, 21, 32, and 64, as shown. Once the larger index size is selected, the entity access scheme is updated to support the larger index (555). In a mapped model, updating the access scheme includes adding to the mapping table. The mapping table may need reconfiguring to reside in contiguous memory to support base plus offset access. At instantiation, an entity's mapping table may be created with a memory allocation larger than required to accommodate additional elements. In a direct model, updating includes allocating an additional element at a memory location contiguous with the other elements, at an appropriate offset, and supplying that offset for use in packing and unpacking processes. Memory allocation during runtime instantiation of a dynamic data structure supporting direct pointer-compression access may allot extra contiguous space to allow for data structure additions. From time to time, the data structure may need to be moved to an alternate location in memory to accommodate the larger data structure in contiguous memory. Appropriate sets of register packed values and/or packing functions, masks, and de-referencing functions will be selected (or existing functions updated at runtime) to correspond with the change in index size. In certain situations, when the processing requirements of updating the data structure and related pointer-compression functions would interfere code execution, the updating of the access scheme with the larger index can be deferred to a convenient time, so long as the threshold is selected appropriately to allow space or the additional data structure element. Note that selecting the largest index value for a given segment size can reduce the overhead required to update the access schemes as the index grows because intermediate reconfigurations are eliminated.

When the increase of UAS does not exceed the threshold (545), then update the access scheme to accommodate the new element or elements using the existing segmentation. This may entail simply appending one or more additional addresses to the list of associated memory addresses in the mapping table for additional elements, particularly if the mapping table has memory allocated already. It may also include reordering the addresses or modifying them based on the sizes and locations of the new elements.

If the update to the element did not increase M (540), then if the update decreased M (565), evaluate whether the reduction in UAS should lead to reducing the index size (570). In similar but reversed fashion to the increase increments, in this embodiment, rather than reduce the index sequentially, the index is reduced when a reduction results in a change of segment sizes. These can be selected as shown in Table 7 or computed as comparing UAS to 2 raised to the power of the index size of the next larger number of segments, or MaxReg/(x+1) using integer division. When UAS falls a threshold below this then the pointer size is updated (575) and set to that value of n supporting x+1 segments. Then update the entity access scheme to support the smaller index (580). This may entail reordering the mapping table, freeing up memory allocated for it if desired, and triggering the appropriate changes in functions accessing the newly sized pointer-compressed addresses. For direct access this may cause the elements of the data structure to be restructured in memory. In one embodiment, an element offset table is maintained linking each element with locations in executable processes that create pointer compression registers and those that access elements accordingly, for use in reprogramming compression registers to use appropriate offset locations as they are updated. This is similar to a mapping table except it is used for maintaining the packing and unpacking processes in response to an update rather than for retrieving an element from or storing one to memory. In situations where the benefits of reducing the index are outweighed by immediate processing needs, reconfiguring of a data structure and associated pointer-compression functions can be deferred to a later time.

When the threshold is not met (570), then update the entity access scheme for the reduced entity size with the existing segmentation. In one embodiment, the existing entry in the mapping table for a deleted element can simply be ignored. The mapped addressing scheme to the remaining elements need not change. Abandoned entries in the mapping table from deleted elements can be recaptured when updating the scheme when the threshold is met. For larger values of n, it may be desirable to release memory when downsizing the index. For smaller values, the mapping table memory may be kept constant.

If the update neither increased (540) or decreased (565) M, then adapt to any change in element size as necessary (590). In some cases, no update is required. For example, when a mapped model is used, each element is accessed via its reference in the mapping table. This level of indirection allows any of the elements to be increased or decreased without requiring a change in the address of the element, and elements of any size can be supported. If a mapped entity is instantiated in memory with its elements in contiguous form, then an element reducing in size will not require an update, nor will an increase in size of an element require an update if extra memory was allocated on instantiation to allow for growth. However, if an element is increased such that elements following it in memory are moved, then a corresponding update to the table will be entered. When a direct model is employed, the elements are by design placed in contiguous memory. Again, an increase in one element's size may or may not require amending the locations of the elements in memory (and therefore a corresponding amendment to the affected elements' offsets) based on whether the memory allocated for the element being increased is currently sufficient. As illustrated earlier, based on the size of an element and the scaling factor deployed, an element's memory allocation may be densely packed or relatively empty. For example, a small element deployed in a data structure with a large scaling factor may have plenty of headroom for growth. In both example models, while a reduction in an element's size will not require a reorganization of the entity's memory layout, freeing memory may be performed when the change is significant enough that net performance will be increased by doing so.

FIG. 5C is a flowchart 502 showing an embodiment of a method for determining the Unit Addressable Space (UAS), as well as associated parameters, for a direct model. A set of potential scale factors may be established for a given embodiment, which may be limited or expansive. In the prior examples, the maximum scale factor was selected to encompass the largest element, and the minimum selected to accommodate the smallest. As was seen, the memory requirements can vary widely based on scaling factor selection. As such, not all potential candidates need to be explored in any given implementation. Each scaling factor in a chosen set, SFⱼ, will be evaluated (512).

The UAS, the number of units of the scaling factor required to address the entire entity, is computed as the sum of the number of units required for each entity element, except for the last one. As detailed above, the final element requires actual memory for storing, but that memory is not required in the unit addressable space to access each element. The unit requirement for an element is the ceiling of the size of the element, Si, divided by the scaling factor, SFⱼ. Thus, the UAS for a candidate scaling factor for an entity with n elements is computed (514) as follows:

$${UAS}_{j} = {\sum }_{i = 1}^{n - 1} ⌈ \frac{{S}_{i - 1}}{{SF}_{j}} ⌉$$

Note that as the scaling factor increases, the UAS approaches that of the mapped model, e.g. UAS=M, as illustrated in the prior direct mapping discussion.

A candidate index size, nⱼ, is computed such that 2 raised to the nⱼ power is more than the threshold larger than UASⱼ (516). A candidate segment size, xⱼ, is then computed as MaxReg/nⱼ (518). The total memory, TMⱼ, required to physically store the element using the candidate scaling factor is then the UAS multiplied by the scaling factor plus the actual memory required to score the last element: TMⱼ=UASⱼ*SFⱼ+Sn−1 (520).

From the candidates, select UAS and SF optimized based on the index size (and related number of segments) and total memory (522). Various embodiments may include differing selection schemes, and the different optimization methods may be deployed for different entities or types of entities. The selected index and number of segments are used for steps 504 and 506 once the method of flowchart 502 is complete.

FIG. 5D is an alternate flowchart 535 illustrating modifications to the event handler for direct model dynamic updating. In addition to the components detailed in FIG. 5B, several additional steps are introduced to illustrate direct access pointer compression models. Here, when there is an increase to M (540), the increase to UAS is computed (542) using the formula shown in 514. As before, the updated UAS is compared to 2ⁿ (545), but, in this example, when that comparison has crossed the threshold, an option is available to re-optimize n for scaling factor and memory (546). A process such as described in FIG. 5C may be deployed. It may be that a change in scaling factor may eliminate the need to increase n (547). If so, then update the entity access scheme with the existing value of n and its corresponding segmentation (560). In this case the entity may need to be reorganized along the element boundaries per the updated scaling factor. Otherwise, proceed to 550 to increase n (550) and update the entity access scheme with the larger index (555).

Similarly, when there is a decrease to M (565), the decrease to UAS is computed (567) using the formula shown in 514. As before, the updated UAS is compared to 2ⁿ (570), but when that comparison has crossed the threshold, an option is available to re-optimize n for scaling factor and memory (571). A process such as described in FIG. 5C may be deployed. It may be that a change in scaling factor may eliminate the need to decrease n (572). If so, then update the entity access scheme with the existing value of n and its corresponding segmentation (560). In this case the entity may need to be reorganized along the element boundaries per the updated scaling factor. Otherwise, proceed to 575 to decrease n (550) and update the entity access scheme with the smaller index (580).

Embodiments have been detailed above using an object or data structure as an example. As stated previously, the compiler can also recognize a collection of elements that are suitable for pointer compression access but not necessarily linked by a traditional data structure. For example, objects of a type may be a collection. The following snippet is an illustration of a collection of objects of type person.

| | |
|---|---|
| 1 | /person := type |
| 2 | name := string |
| 3 | age := string |
| 4 | |
| 5 | +p1 : person (name : “John”, age :“33”) |
| 6 | +p2 : person (name : “Drake”, age :“43”) |
| 7 | +p3 ... |
| 8 | +p4 ... |
| 9 | ... |
| 10 | +p50 |

In this example the type “person” is defined with “name” and “age” (lines 1-3). A series of persons p1-p50 are then created (lines 5-10). The compiler recognizes the 50 persons as a collection. The compiler automatically generates a “shadow” data structure for use in pointer compression compilation of the collection as well as for setup, modification and access of elements of the collection at runtime. If a mapped model is selected for the collection, the person objects may be instantiated at runtime utilizing any memory management technique or structure, or with no specific structure at all. In this example, the 50 objects can be represented by an 8-bit index, and a mapping table (e.g., the shadow data structure) associating each person object to its respective memory location is generated by the compiler. The compiler will also generate code to perform the required packing and dereferencing for source code defined accesses to the objects. If a direct model is selected, the compiler generates code to cause the objects to be instantiated in memory locations suitable for direct access using pointers and scaling, as detailed above. Here, the shadow data structure created by the compiler includes structure introduced to organize the objects at the appropriate scale boundaries for pointer access, and maintaining a table, for example, of the objects and their offset pointer values, which may be static or dynamically updated.

Dynamic updating may also be deployed with collections of objects of a type. The compiler generates code to update the collection when an object is created or deleted. In one embodiment, an event handler for such events has appropriate instructions injected to perform updating such as described in FIGS. 5A-5D. The number of objects M of a type may be maintained and used to compute UAS for the collection of those objects (along with the objects sizes with direct model). It may be that some objects are instantiated at startup and M is a positive number to start. The collection of objects may remain empty (M=0) until a create instruction is encountered and instantiates one. The index size will adapt for increases and decreases in the number of objects in the collection, as detailed above.

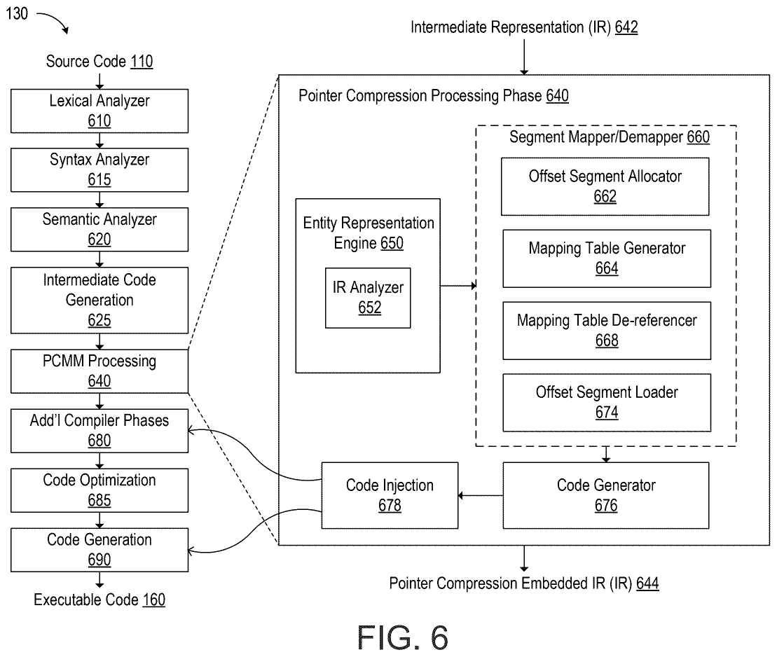

FIG. 6 is an example compiler 130 illustrating PCMM processing on an intermediate representation and an example pointer compression processing phase 640. Lexical analyzer 610 performs lexical analysis, also known as scanning, where source code is 110 is converted into a sequence of lexical units or tokens. Tokens are the smallest meaningful units of a programming language, such as keywords, identifiers, operators, and literals.

Syntax analyzer 615 performs syntax analysis, also known as parsing, where the compiler checks whether the sequence of tokens generated by the lexical analyzer 610 conforms to the rules defined by the programming language's grammar. This analysis typically involves constructing a parse tree or syntax tree (e.g. an AST) that represents the hierarchical structure of the source code.

Semantic analyzer 620 performs semantic analysis where the compiler examines the meaning of the statements and expressions in the source code beyond their syntactic structure. During semantic analysis, the compiler checks for semantic correctness, such as type compatibility, undeclared variables, and adherence to language-specific constraints. It also performs various optimizations and transformations based on the semantic properties of the code.

Intermediate code generation module 625 generates an intermediate representation (IR) 642 of the source code after semantic analysis and optimization, but before the final machine code. Often during intermediate code generation, the compiler translates high-level source code into an IR that is closer to the target machine language but still independent of the target machine architecture. This intermediate code is typically in the form of low-level instructions or an intermediate language. The main purpose of intermediate code generation is to provide a platform-independent representation of the source code that facilitates further optimization and simplifies the task of generating machine code for different target architectures. A variety of compiling processes may be applied to code in intermediate form. IR 642 may include one or more of any of a variety of forms, including but not necessarily a control flow graph, static single assignment, three-address code, intermediate representation language, an abstract syntax tree, and the like.

Code optimization module 685 is where the intermediate representation is improved to enhance its efficiency in terms of execution time, memory usage, or other performance metrics. During code optimization, the compiler applies various techniques and transformations to the intermediate code to eliminate redundant operations, minimize resource usage, and improve the overall quality of the generated code. Optimization techniques may include constant folding, dead code elimination, loop optimization, and many others. The primary goal of code optimization is to produce optimized code that executes more efficiently on the target platform, resulting in improved performance and reduced resource consumption. Other embodiments may employ different or additional compiler phases processing the IR for other purposes.

Code generation module 690 is where the optimized intermediate representation of the source code is translated into executable machine code specific to the target platform. During code generation, the compiler maps the instructions and constructs of the intermediate code to the corresponding machine instructions of and taking advantage of the specific features and optimizations offered by the target architecture. This involves generating assembly code or machine code that directly controls the behavior of the target hardware. Note that code generation may be carried out in multiple phases. For example, a low-level language such as c/llvm may be an intermediate target of code generation 690. An intermediate level compilation can be further processed into executable code 160 for one or more target processors and/or architectures.

In this embodiment, The PCMM processing phase 640 operates on IR 642 to produce Pointer Compression Embedded IR 644, which is used in additional compiler phases 680 and leading to code optimization and code generation. The offset register segmentation code that is generated can be compiled along with other code in the IR or can be injected into the executable during code generation 690, or a combination of both, as indicated in FIG. 6.

The description for compiler 130 support of PCMM is provided illustratively. Any number of other embodiments may be deployed where PCMM instructions are generated in any compiler phase or code format. It will be appreciated that it may be implemented in alternate ways over any of various phases and passes of compilation, using the principles described herein.

The Entity Representation engine 650 comprises the IR Analyzer 652. The IR Analyzer is responsible for extracting the Control Flow Graph (CFG) from the input IR and conducting constraint analysis to determine the number of elements contained within each entity. Further type definition checks of the entity assist in determining the size of each element within the entity. The output of the IR Analyzer includes the names and the number of elements present in each entity. The sizes of the entities may be provided as well as needed for developing a mapping table or sizing index scaling factors for direct access, as detailed above.

The Segment Mapper/De-mapper 660 is comprised of four components: the Offset Segment Allocator 662, the Mapping Table Generator 664, the Mapping Table De-referencer 668 and the Offset Segment Loader 674. These components collaborate to determine the minimum number of bits (n) required to uniquely represent each element in a given entity. Using this value of n, the mapping table and its corresponding de-referencer are generated. Note that, while a mapping table, e.g. a list of associated addresses for elements, is produced at runtime for the mapped model, and such a list is not used for direct access, the mapping table is useful during compilation to associate pointer indexes with elements while generating code to pack registers or select pointers for element access with either model (or combination thereof). In the following description, the mapping table used during compilation is related to but distinct from a mapping table that may be generated during runtime.

The Offset Segment Allocator 662 first calculates the minimum number of bits (n) required to uniquely represent each element in a given entity. It generates the mapping table, associating pointer indexes with entity elements. The Offset Segment Allocator 662 is also responsible for generating the mask or set of masks and determining the correct shift values for retrieving the pointer compression address from each of the offset segment in the offset register, in accordance with n and the model type selected. Offset Segment Allocator 662 generates instructions (G1) for instantiating the entity at runtime and its associated runtime mapping table (mapped model) or instantiating the entity with appropriate scaled element addresses (direct model). Masks and shift values for accessing pointer compression addresses from offset segments in a pointer register are initialized based on index size and scaling factor, when applicable.

The Mapping Table Generator 664 generates instructions (G2) for populating the mapping table at runtime and modifying it in response to an entity update (mapped model) or modifying the element's address alignment as necessary in response to an entity update (direct model). Masks and shift values for accessing pointer compression addresses from offset segments in a pointer register are updated in response to a change in index size or scaling factor, when applicable.

The Mapping Table De-referencer 668 generates instructions (G3) for accessing entity elements at runtime according to affect the accesses defined by the developer in source code, yet adapted to execute the pointer-compression accesses as defined by the selected memory model and index size, as modified when support for dynamic entities is utilized.

The Offset Segment Loader 674 is responsible for creating instructions (G4) that prepare register values used to segment the offset register according to the value of n. Based on the accesses required to elements of the entity, appropriate offsets for those entity accesses are prepared and loaded into an offset register or stored for loading into the offset register when access is needed.

The Code Generator 676 takes in the generated instructions (G1, G2, G3, and G4) and converts some or all of them into a machine code format. Instructions can also be maintained in IR format. The Code Generator 676 ensures that machine code is optimized and compatible with the target system. This process can involve converting the instructions into binary code or bytecode, which is then translated into machine code. Instructions maintained in IR format can be further processed by the compiler.

The Code Injector 678 receives the generated machine code and inserts it into the appropriate location within the final executable during code generation 690. Instructions remaining in IR format are injected to IR for further processing in additional compiler phases 680, and any subsequent processing.

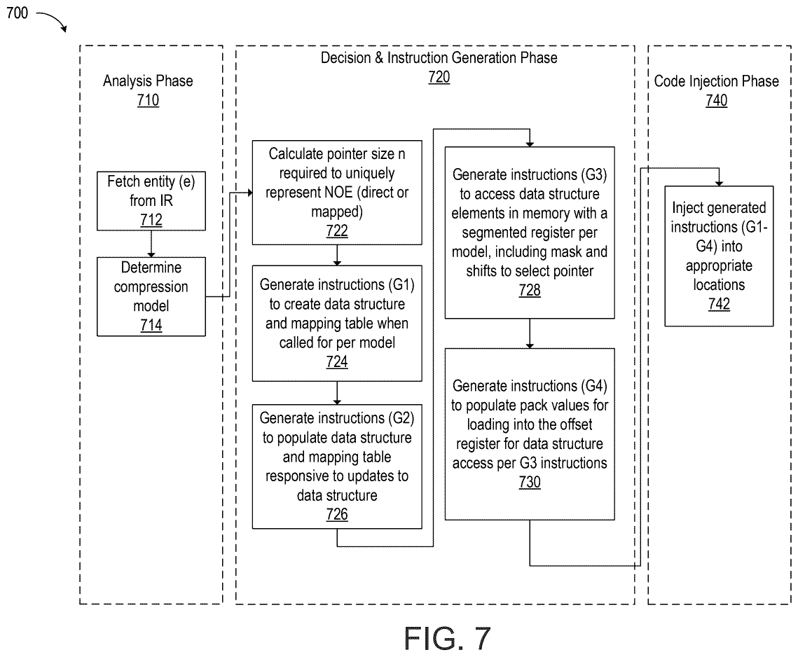

FIG. 7 is a flowchart 700 illustrating pointer compression processing in three phases: the Analysis Phase 710, the Decision and Instruction Generation Phase 720, and the Code Injection Phase 740. In the analysis phase, the IR analyzer 652 receives the IR 642 as input and examines each entity e within the IR (712). Based on the Number of Elements (NOE) and their sizes, a compression model is determined for each entity (714).

In the Decision and Instruction Generation Phase 720, the pointer size n is determined as the number of bits required to uniquely represent the NOE of the element, whether with a mapped or direct model (722). Offset Segment Allocator 662 then generates instructions (G1) for creating the data structure and mapping table, when called for, and generates the required masks and shift values for accessing offset segments (724). Mapping Table Generator 664 generates instructions (G2) for populating the data structure and mapping table for the entity e and updating them responsive to updates to entity e (726). The Mapping Table De-referencer 668 generates instructions (G3) to access the data structure elements in memory using the segmented register, per the selected model, and using appropriate mask and shifts to select pointers to the elements (728). Offset Segment Loader 674 generates instructions (G4) to populate pack values for loading into the offset register for data structure access per G3 instructions (730).

In the Code Injection Phase 740, the code generator takes in the generated instructions (G1, G2, G3, and G4) and converts them into a machine code format. The code generator ensures that the machine code is optimized and compatible with the target system, allowing for efficient execution. This typically involves converting the instructions into binary code, which is then translated into machine code. Additionally, or alternatively, the part or all of the generated instructions may be inserted as IR and processed further in additional compilation phases. Finally, the Code injector inserts the generated machine code into the appropriate locations within the final executable. The phases and order of steps of FIG. 7 are illustrative. In any given embodiment, the steps are likely to be iterative. For example, access instructions (G3) and packing instructions (G4) may be generated concurrently for a function or procedure, then subsequently iterated again on another part of the code, until the compiler has optimized to implement pointer compression effectively.

Example 1 is pseudocode illustrating user-developed source code for a game:

| 1 | // Source code | |
|---|---|---|
| 2 | | |
| 3 | Player: Type { | |
| 4 | Name | |
| 5 | Character | |
| 6 | ... | |
| 7 | | |
| 8 | // Characteristics that are static during a battle | |
| 9 | Strength | |
| 10 | Wisdom | |
| 11 | Agility | |
| 12 | Intelligence | |
| 13 | Experience | |
| 14 | ... | |
| 15 | // Characteristics that are mutable during battle | |
| 16 | Health | |
| 17 | Energy | |
| 18 | ... | |
| 19 | | |
| 20 | // Set of characteristics and items each player can add during gameplay | |
| 21 | Attribute [1:25] | |
| 22 | Weapon[1:25] | |
| 23 | Armor[1:10] | |
| 24 | Asset[1:50] | |
| 25 | ... | |
| 26 | | |
| 27 | // Each player has a configuration set for 4 different battle types, | |
| | selects 6 elements from Attribute, Weapon, Armor, and Asset | |
| 28 | BattleModeConfig1[1:6] | |
| 29 | BattleModeConfig2[1:6] | |
| 30 | BattleModeConfig3[1:6] | |
| 31 | BattleModeConfig4[1:6] | |
| 32 | ... | |
| 33 | } | |
| 34 | | |
| 35 | function RollDie( ) | //Returns random number between 1:6 |
| 36 | function BattleReps( ) | //Returns random number between 2:20 |
| 37 | | |
| 38 | function Battle(PlayerList, BattleMode) { | |
| 39 | for (let i = 0; i < PlayerList.length; i++) { | |
| 40 | for (let j = i + 1; j < PlayerList.length; j++) { | |
| 41 | BattleMatch(PlayerList[i],PlayerList[j],BattleMode); | |
| 42 | } | |
| 43 | } | |
| 44 | } | |
| 45 | | |
| 46 | function BattleMatch(player1, player2, BattleMode) { | |
| 47 | match BattleMode: | |
| 48 | case 1: | |
| 49 | player1_tools = player1.BattleModeConfig1 | |
| 50 | player2_tools = player2.BattleModeConfig1 | |
| 51 | case 2: | |
| 52 | player1_tools = player1.BattleModeConfig2 | |
| 53 | player2_tools = player2.BattleModeConfig2 | |
| 54 | case 3: | |
| 55 | player1_tools = player1.BattleModeConfig3 | |
| 56 | player2_tools = player2.BattleModeConfig3 | |
| 57 | case 4: | |
| 58 | player1_tools = player1.BattleModeConfig4 | |
| 59 | player2_tools = player2.BattleModeConfig4 | |
| 60 | case _: | |
| 61 | player1_tools = player1.BattleModeConfig1 | |
| 62 | player2_tools = player2.BattleModeConfig1 | |
| 63 | | |
| 64 | | |
| 65 | player1attributes = [player1.Strength | |
| 66 | | player1.Wisdom |
| 67 | | player1.Agility |
| 68 | | player1.Intelligence |
| 69 | | player1.Experience |
| 70 | | player1.Health |
| 71 | | player1.Energy] |
| 72 | | |
| 73 | player2attributes = [player2.Strength | |
| 74 | | player2.Wisdom |
| 75 | | player2.Agility |
| 76 | | player2.Intelligence |
| 77 | | player2.Experience |
| 78 | | player2.Health |
| 79 | | player2.Energy] |

| | |
|---|---|
| 80 | |
| 81 | reps = BattleReps; |
| 82 | for (let k = 0; k < reps; k++) { |
| 83 | tool_select = RollDie; |
| 84 | [player1attributes[5:6], player2attributes[5:6]] = |
| 85 | fight(player1attributes, player1_tools[tool_select], |
| 86 | player2attributes, player2_tools[tool_select], |
| 87 | BattleMode) |
| 88 | } |
| 89 | |
| 90 | player1.Health = player1attributes[5] |
| 91 | player1.Energy = player1attributes[6] |
| 92 | player2.Health = player2attributes[5] |
| 93 | player2.Energy = player2attributes[6] |
| 94 | |
| 95 | } |
| 96 | |
| 97 | function Fight (player1, tool1, player2, tool2, BattleMode) { |
| 98 | |
| 99 | // The health and energy of the players are responsive to |
| 100 | // some function of all the attributes, tools and the mode |
| 101 | |
| 102 | Return [player1[5:6], player2[5:6]] |
| 103 | } |
| 104 | |
| 105 | Player p1 |
| 106 | Player p2 |
| 107 | ... |
| 108 | Player p20 |
| 109 | |
| 110 | Battle ([p1, p2, ... p20], 3) |
| 111 | ... |

### Example 1. User Generated Source Code

At line 3 a type definition is given for an object of type Player. For simplicity, the elements of the player are not typed. Ellipses throughout the source code indicate that other elements and statements may be included but aren't shown. The illustrations herein are simplified to include elements needed to illustrate various aspects. Those of skill in the art will readily adapt the principles to source code of any programming language.

Each player has a Name (line 4) and a Character definition (line 5). Lines 9-13 introduce characteristics of the player that remain static during battle: Strength, Wisdom, Agility, Intelligence, and Experience. Lines 16-17 define characteristics that are mutable during battle: Health, and Energy. During the game, each player can earn new characteristics or accumulate additional items. These are collected in up to 25 attributes in Attribute (line 21), up to 25 weapons in Weapon (line22), up to 10 sets of armor in Armor (line 23), and up to 50 other assets in Asset (line 25). From these attributes, each player populates 4 battle mode configurations with 6 items/attributes in BattleModeConfig1-4 (lines 28-31). Each element in a configuration is a reference to an element contained in the player's Attribute, Weapon, Armor, or Asset.

A function RollDie (line 35) returns a random number between 1 and 6. A function BattleReps returns a random number between 2 and 20. Function Battle (lines 38-44) takes a list of players (PlayerList) and iteratively calls function BattleMatch for each unique pair of players in the list, using a selected battle mode (BattleMode). Function BattleMatch (lines 46-96) pits two players against each other. Based on the battle mode parameter, one of four BattleModeConfig1-4 is selected for each player (lines 47-62) and the selected battle mode configuration is accessed and assigned to player1_tools and player2_tools, respectively. In addition, the characteristics introduced earlier (Strength, Wisdom, Agility, Intelligence, Health and Energy) are accessed for each player and assigned to playerlattributes and player2attributes, respectively (lines 65-79).

For each call to BattleMatch, a number of repetitions of function Fight will be called (lines 81-88). The number of repetitions, reps, is a random number between 2 and 20, supplied by function BattleReps. Then, for each repetition, a call to RollDie produces a random number between 1 and 6, and that number is used to select a tool for each player for the fight repetition. The call to function fight includes the attributes for both players and the selected tool, as well as the battle mode. As mentioned above, the first five characteristics for each player remain static during battle. However, Health and Energy for each player can affected during each repetition, and these values are passed back from function Fight (lines 97-103). The details of function Fight are not included, but some function of all the attributes, selected tools, and battle mode cause the health and energy of each player to be potentially modified during the fight repetition. At the end of BattleMatch (lines 90-93) these Fight results are written back to the corresponding elements of the respective player objects. Finally, 20 players are instantiated (lines 105-108) and a call to Battle with a list of the 20 players p1-p20 and battle mode of 3 selected.

In this example the compiler will analyze the code and determine that pointer compression for the Player type definition will be beneficial. A direct compression model will be chosen. Example 2 details pseudocode illustrating the results of the compiler performing pointer compression memory management processing on the source code of Example 1.

| | |
|---|---|
| 1 | // Source modified post-PCMM processing |
| 2 | |
| 3 | // G1 Utility Instructions |
| 4 | function initializePlayer (playerName) { |
| 5 | ... |
| 6 | } |
| 7 | |
| 8 | function playerElementToOffset (elements) { |
| 9 | |
| 10 | for (let j = 0; j < elements.length; j++) { |
| 11 | offset[j] = tableLookup(elements[j]); |
| 12 | } |
| 13 | return offset |
| 14 | } |

### Example 2. Compiler Modified Source Post PCMM

Example G1 utility instructions are shown in lines 3-14. They will be inserted by the compiler for use by additional G1 instructions detailed further below. Additional or alternate instructions may be generated by the compiler. Function initializePlayer (lines 4-6) initializes a Player object named playerName at runtime. The details (not shown) perform traditional object instantiation, such as memory allocation, assigning the object to a unique memory address, and other tasks related to memory management functions and ultimately, once fully compiled to an executable, tailored to a particular operating system and/or computer architecture. Pointer compression instructions operable at runtime will also be included in the object instantiation. For example, when a mapped model is deployed, the mapping table linking the physical memory locations of the elements of the object (or other data structure) with the pointer-compression indices is created as the object is instantiated. When a direct model is deployed, the instructions cause the elements to be instantiated in memory locations accessible by the pointer-compression indices according to the scale factor. During compilation, the compiler may generate a mapping table linking elements and their associated indices for use in PCMM processing.

Function playerElementToOffset (lines 8-14) takes an element or list of elements and returns an offset or list of offsets for type Player. During compiling, a call to this function will be collapsed into an index or set of indices when the references to the Player elements are static, as they are in this example. Dynamic objects can also be supported for parallel access providing those parallel elements remain in correlated positions (either by placing dynamic elements after static elements or otherwise maintaining the correlated positions). Note that the order of elements in a data structure once compiled need not match the order of elements of that data structure in source code.

The compiler can de-reference a string identifying the data structure element as well as an indirect reference to an element. For example, in an argument, a string matching an element name returns that element's offset (e.g. the offset of p1. Strength). At runtime, a variable may be referencing an element, e.g. p1.BattleModeConfig3[4]=p1.Armor [4]. Here then, playerElementToOffset (BattleModeConfig3[4]) returns the offset of element Armor [4]. Pointer compression compiling can generally look for these types of accesses within the same base location and generate supporting instructions.

BattleModeConfig is an example of a small data structure, like an array or list. In general, a data structure may be a containment, e.g. a data element, of another data structure, i.e. the latter has the former as a container. In some cases, a container may be stored outside of the pointer-compressed data structure (referred to as external) and the pointer-compression index will access a non-compressed pointer to the container. In other cases, such as this one, the container (BattleModeConfig) is stored within the data structure (referred to as local), object Player in this case. Here, since the container is a list of Player elements, each accessible within the pointer-compression structure, the compiler stores the values as pointer-compression indices. In general, when an element of a data structure represents an element within the data structure (including local containers, the compiler has the option of storing the reference as a compression pointer and automatically generating the appropriate access instructions to apply when the element is accessed. The compiler can also look for situations such as these and generate more optimized code and return essentially what a BattleModeConfig is in this instance, the value of a packed register. Thus, instruction G4A reduces to loadPack04 (BattleModeConfig3).

| | |
|---|---|
| 15 | //G2 Utility Instructions |
| 16 | |
| 17 | function updatePlayerPack (playerName, index, SF) { |
| 18 | ... |
| 19 | } |

### Example 2. Compiler Modified Source Post PCMM (Cont.)

The current example is not illustrating dynamic updating, that is, where the pointer-compression index size and/or the scaling factor changes based on an update to the data structure, as described above. However, if it were to be supported for a Player, then one embodiment is to have an event handler emitted that determines whether a change to the scheme is required, using one of the examples in FIGS. 5A-5D. Then, when a change occurs, a call to function updatePlayerPack (lines 15-19) with a player name, index, and scaling factor is made. It is like initializePlayer but reallocates elements in memory along updated scaling factor boundaries and/or generates new offset tables. In addition, support for dynamic updating to G3 and G4 instructions is included.

During compilation, the compiler will have noted all of the functions, accesses, packed registers, and so forth, that are required to implement pointer compression for a data structure. The compiler then generates the appropriate instructions to make the appropriate modifications when a runtime call to update these is encountered. For example, a mapping table for an object is maintained, and, when necessary, the mapping table is modified for an update in index size. If the scale factor is changed, instructions to relocate the elements in memory will be executed. Functions or instructions to pack registers will be altered or selected for an update in index size. Access instructions and/or functions will be updated as well. There are a variety of techniques readily adaptable by one of skill in the art. One example is illustrated below with respect to FIG. 9.

| | |
|---|---|
| 20 | // G4 Utility Instructions |
| 21 | function packRegister (regVar, offset, position) { |
| 22 | } |
| 23 | |
| 24 | function packRegisterList (offsets) { |
| 25 | // Code to pack list of offsets into a variable, reg_val, for loading in a |
| | pointer register, first in LSB position and increasing therefrom |
| 26 | return reg_val |
| 27 | } |
| 28 | |
| 29 | loadBase01(object_address) |
| 30 | loadBase02(object_address) |
| 31 | loadBase03(object_address) |
| 32 | loadBase04(object_address) |
| 33 | loadPack01(pack_val) |
| 34 | loadPack02(pack_val) |
| 35 | loadPack03(pack_val) |
| 36 | loadPack04(pack_val) |
| 37 | loadPack05(pack_val) |
| 38 | loadPack06(pack_val) |

### Example 2. Compiler Modified Source Post PCMM (Cont.)

Several G4 utility functions for populating pack values and offset registers are detailed in lines 20-38. Function packRegister (lines 20-22) receives a value regVar and inserts a single pointer-compression offset in regVar at the location identified by position. Function packRegisterList (lines 24-27) receives a list of offsets and returns a variable, reg_val, with the offsets packed. This variable is useful for storing in an offset register. Functions LoadBase01-04 (lines 29-32) are used to load a base address for pointer-compression into one of 4 base registers, respectively. Other access functions, detailed below, will utilize one or more of the base registers, identified by an associated base register number 1-4. Similarly, 6 offset registers are loaded with a packed value with functions loadPack01-06 (lines 33-38) and are utilized in access functions via an offset register number 1-6. The compiler can determine how many base and offset registers to utilize based on the source code during analysis for G4 instruction generation and may take into consideration the capabilities of one or more target architectures.

| | |
|---|---|
| 39 | //G3 Utility functions |
| 40 | |
| 41 | direct_pack_access(base, pack, offset) |
| 42 | |
| 43 | direct_pack_double_access (base1, pointer1, base2, pointer2, offset) |
| 44 | |
| 45 | direct_compression_double_access_common (base1, base2, common, offset) |
| 46 | |
| 47 | direct_pack_double_write_common (value1, value 2, base1, base2, common, |
| | offset) |

### Example 2. Compiler Modified Source Post PCMM (Cont.)

Example G3 utility functions are illustrated in lines 39-47. G3 instructions are used to access data elements with reads/writes aka loads/stores using pointer-compression techniques. Aspects of various accesses are illustrated using generated source code, and in one embodiment a compiler may do just that. But, naturally, a compiler need not introduce human-readable examples and can proceed to compile from intermediate representation to intermediate representation and/or low-level code, assembly, or machine code.

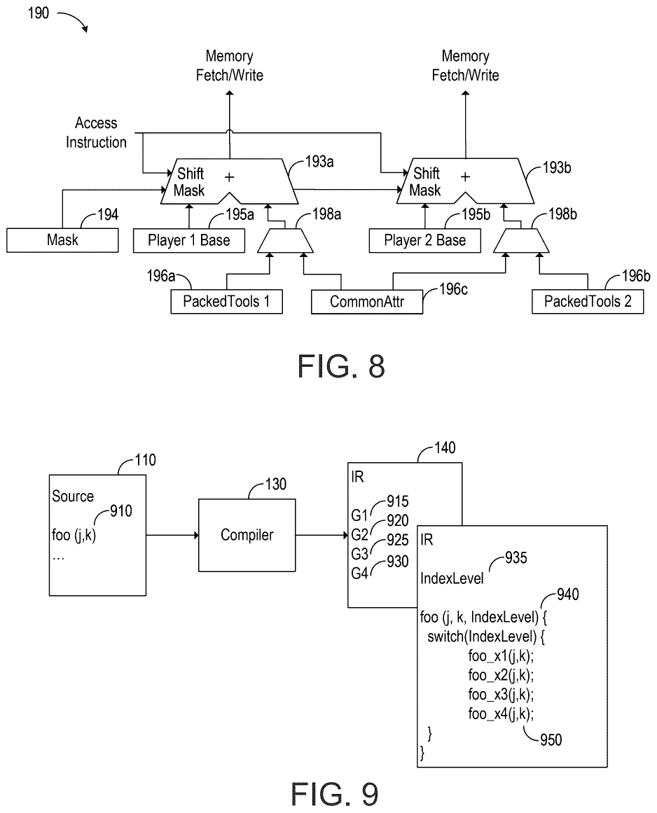

To illustrate various aspects illustrated in Examples 1 and 2, and the utility of these indicative G3 utility instructions, a portion of CPU 190 is detailed further in FIG. 8. This example illustrates a memory (150) which supports parallel accesses. The compiler will generate instructions which can take advantage of the features of this example CPU but can map onto alternate architectures as well. Two ALUs 193a and 193b are deployed, one for each of a pair of players, in this example, to provide simultaneous access to memory. An access instruction supplies a shift value to select the pointer compression index as well as a read/write indicator (not shown). A mask value suitable for the index size and scaling factor is loaded in mask register 194 (note that registers in a typical ALU are general purpose, most can be selected for any of the various ALU functions, and labels given to a particular register are for illustrative purposes only). The base memory location for Player 1 is stored in register 195a. The base memory location for Player 2 is stored in register 195b. Packed tools for Player 1 is stored in register 196a. Packed tools for Player 2 is stored in register 196b. Common attributes used for both players are stored in register 196c. Selectors 198a and 198b select packed tools or common attributes for adding to player base offsets in ALUs 193a and 193b, respectively. The output of the ALUs provides addresses for read or writes to memory.

The G3 utility functions take advantage of these architecture features. Since they are compiler-generated based on the compiler-determined index size and model, there is no need to specify those attributes. The function direct_pack_access (line 41) fetches from memory at a location specified by the integer parameters base, pack, and offset. Base selects a base address in one of the aforementioned 4 base registers. Pack selects one of the 6 aforementioned offset registers. Offset selects one of the pointer indices contained in the selected offset register. The shifting and masking steps are included in the function. Using the FIG. 8 example, the offset will indicate which shift value is applied to the ALU 193, and the appropriate mask will have been stored in mask register 194. This function is an example of a general purpose G3 access.

When the compiler encounters read accesses to two or more objects, or data structures in general, where the accesses are selected from a group of elements with a common selector, it can take advantage of this commonality and share an offset value to access each object. The function direct_pack_double_access (line 43) is used to access an element indicated by offset in each of two objects, the element for the first located with base1 and pointer1 and the element for the second located with base2 and pointer2. When the underlying architecture supports it, as in FIG. 8, this allows for parallel access to the elements in each object. This is not a requirement, as the compiler targeting an architecture without the capability can insert code for serial accesses.

When the compiler encounters read accesses to the same element or elements of two or more objects of the same type, or any similar data structures, it can take advantage of the symmetrical accesses and share both an offset value and a common pointer-pack register to access each object. The function direct_pack_double_access_common (line 45) is used to access an element indicated by offset in each of two objects, the element for the first located with base1 and a common register (e.g. 196c) and the element for the second located with base2 and the common register. When the underlying architecture supports it, as in FIG. 8, this allows for parallel access to the elements in each object. This is not a requirement, as the compiler targeting an architecture without the capability can insert code for serial accesses. Whether serial or parallel, this technique allows one packed register to be generated during compilation that can be used in processing any number of objects. Note that selectors 198a and b are shown to illustrate switching between player specific registers (196a and b) and the common register (196c). In typical CPUs, the ALU has multiplexing capability to select from all or nearly all the general-purpose registers and special-purpose registers for implementing a wide variety of instructions. The instruction and/or registers are used to perform these selections (details not shown).

A write access is similar. The function direct_pack_double_write_common (line 47) writes a first value, value1, at a location identified by base1 and the common offset register, and a second value, value 2, at a location identified by base2 and the common offset register, the pointer in the common offset register selected offset. The compiling steps to determine when the source code calls for these writes, other than the memory data flow direction, are the same as for read accesses. A single general write access, similar to direct_pack_access, and one for a common selector, such as direct_pack_double_access, could have been included but are omitted as they are not required by the current example.

The following replaces and/or consolidates the Example 1 function Battle after PCMM processing, with additional G1-G4 instructions, and using the utilities introduced as a layer of abstraction to hide the details while highlighting various pointer-compression memory management aspects.

| 48 | function Battle(PlayerList, BattleMode) { | |
|---|---|---|
| 49 | | |
| 50 | //G4 | |
| 51 | var packedTools1, packedTools2 | |
| 52 | | |
| 53 | loadPack04(packRegisterList(playerElementToOffset(BattleModeConfig3))) | |
| 54 | loadPack03(packRegisterList(playerElementToOffset(Strength, Wisdom, | |
| | Agility, | Intelligence, Experience, Health, Energy)) |
| 55 | | |
| 56 | //Source | |
| 57 | for (let i = 0; i < PlayerList.length; i++) { | |
| 58 | | |
| 59 | //G3 | |
| 60 | loadBase01(PlayerList[i]) | // Base reg for |
| | player1 | |
| 61 | | |
| 62 | //G3 (direct_pack_access) and G4 (packing to packedTools1) | |
| 63 | | |
| 64 | packRegister(packedTools1, direct_pack_access(1, 4, 0), 0) | |
| 65 | packRegister(packedTools1, direct_pack_access(1, 4, 1), 1) | |
| 66 | packRegister(packedTools1, direct_pack_access(1, 4, 2), 2) | |
| 67 | packRegister(packedTools1, direct_pack_access(1, 4, 3), 3) | |
| 68 | packRegister(packedTools1, direct_pack_access(1, 4, 4), 4) | |
| 69 | packRegister(packedTools1, direct_pack_access(1, 4, 5), 5) | |
| 70 | loadPack01(packedTools1) | |
| 71 | | |
| 72 | //Source | |
| 73 | for (let j = i + 1; j < PlayerList.length; j++) { | |
| 74 | loadBase02(PlayerList[j]) | // Base reg for |
| | player2 | |
| 75 | | |
| 76 | packRegister(packedTools2, direct_pack_access(2, 4, 0), 0) | |
| 77 | packRegister(packedTools2, direct_pack_access(2, 4, 1), 1) | |
| 78 | packRegister(packedTools2, direct_pack_access(2, 4, 2), 2) | |
| 79 | packRegister(packedTools2, direct_pack_access(2, 4, 3), 3) | |
| 80 | packRegister(packedTools2, direct_pack_access(2, 4, 4), 4) | |
| 81 | packRegister(packedTools2, direct_pack_access(2, 4, 5), 5) | |
| 82 | loadPack02(packedTools2) | |
| 83 | | |
| 84 | //G3 retrieving attributes for two players, parallel access | |
| 85 | // Player 1 & 2 bases added to offset reg 3 (CommonAttr) | |
| 86 | | |
| 87 | [player1attributes[0], player2attributes[0]] = | |
| 88 | | direct_pack_double_access_common (1, 2, 3, 0,) |
| 89 | [player1attributes[1], player2attributes[1]] = | |
| 90 | | direct_pack_double_access_common (1, 2, 3, 1) |
| 91 | [player1attributes[2], player2attributes[2]] = | |
| 92 | | direct_pack_double_access_common (1, 2, 3, 2) |
| 93 | [player1attributes[3], player2attributes[3]] = | |
| 94 | | direct_pack_double_access_common (1, 2, 3, 3,) |
| 95 | [player1attributes[4], player2attributes[4]] = | |
| 96 | | direct_pack_double_access_common (1, 2, 3, 4,) |
| 97 | [player1attributes[5], player2attributes[5]] = | |
| 98 | | direct_pack_double_access_common (1, 2, 3, 5) |
| 99 | [player1attributes[6], player2attributes[6]] = | |
| 100 | | direct_pack_double_access_common (1, 2, 3, 6) |

### Example 2. Compiler Modified Source Post PCMM (Cont.)

Additional G4 instructions are inserted in lines 50-54. Two variables packedTools1 and packedTools2 are initialized (line 51) and will be used in lieu of the non-compressed variables player1_tools and player2_tools. The fourth pack register is loaded with the BattleModeConfig3 element indices (line 53). The third pack register is loaded with the common element indices (line 54). The first loop from the original source then begins to select each player in the PlayerList (line 57). G3 instruction loadBase01 (line 60) puts Player 1's base address in base one. Then a combination of G3 and G4 instructions are inserted (lines 64-70), where player 1's packed tools are retrieved using the base register 1, pack register 4, and each of the 6 offsets to retrieve the 6 elements. Then the first pack register is loaded with player 1's packed tools. Note that, as detailed above, since the BattleModeConfig3 elements are references to selected elements in the object, the compiler has stored the pointer indices in the object, and once retrieved they are directly inserted into the pointer-pack register. The compiler could have used packRegisterList (PlayerList[i].BattleModeConfig3) but element by element packing is illustrated here. Variable elements determined at runtime, identified in list element BattleModeConfig3, causes the offsets of those elements to be stored into packedTools1. Elements identified in BattleModeConfig3 can be unique to each player, and are variables, changing at runtime (but constant during a call to function Battle).

The second loop selects the player 2 for each of the remainder of PlayerList (line 73). The same process repeats to pack Player 2's base and packed tools register, using the same pack register 4 (lines 76-82). Then the player attributes for Player 1 and Player 2 are loaded (using parallel access when supported) using their respective base registers and the common pack register 3 (lines 87-100).

| | |
|---|---|
| 101 | //Source |
| 102 | reps = BattleReps; |
| 103 | for (let k = 0; k < BattleReps; k++) { |
| 104 | //G3 retrieving tools for each player, parallel access |
| 105 | [tool1, tool2] = direct_pack_double_access(1, 1, 2, 2, RollDie) |
| 106 | |
| 107 | // The health and energy of the players are responsive to |
| 108 | // some function of all the attributes, tools and the mode |
| 109 | } |
| 110 | |
| 111 | // G3 - writing health & energy back to player objects [i] and [j] after |
| | battle is complete |
| 112 | direct_pack_double_write_common (player1attributes[5], |
| | player2attributes[5], 1, 2, 3, 5) |
| 113 | direct_pack_double_write_common (player1attributes[6], |
| | player2attributes[6], 1, 2, 3, 6) |
| 114 | |
| 115 | } |
| 116 | } |
| 117 | } |
| 118 | |
| 119 | // G1 |
| 120 | p1 = initializePlayer (p1) |
| 121 | p2 = initializePlayer (p2) |
| 122 | ... |
| 123 | p1 = initializePlayer (p20) |
| 124 | |
| 125 | // Source |
| 126 | Battle ([p1, p2, ... p20], 3) //BattleMode = 3 constant |
| 127 | ... |

### Example 2. Compiler Modified Source Post PCMM (Cont.)

Additional G3 instructions are inserted for retrieving tools for each player (line 105). Then some function of all the attributes, tools, and mode cause an update to the health and energy of each player. This loop (lines 102-109) illustrates multiple sequential accesses to both objects with no requirement of updating any of the registers. A simple die roll is used to select the tool for each player each round. Then those updated attributes are written back to both player objects using G3 instructions (lines 112-113). G1 instructions (lines 120-123) initialize the player objects.

| | |
|---|---|
| 1 | ; Assume: |
| 2 | ; rax = Base address |
| 3 | ; rbx = Offset register with packed pointers |
| 4 | ; rcx = Mask |
| 5 | ; rdx = Shift value |
| 6 | ; rsi = Receiving register for the loaded value |
| 7 | |
| 8 | ; Step 1: Mask, shift, and add base in one instruction with LEA |
| 9 | ; Compute effective address with LEA |
| 10 | lea rdi, [rax + (rbx & rcx) << cl] |
| 11 | |
| 12 | ; Step 2: Load the value from the computed address |
| 13 | mov rsi, [rdi] ; Load the value into rsi |

### Example 3. Assembly Code for PCMM Access

The ALU of FIG. 8 allowed for PCMM accesses with a single instruction, and such an embodiment may be deployed using special-purpose hardware. For ARM and x86 architectures, two instructions may be required. An ARM processor can perform the shift on offset, add it to the base, and fetch in one instruction. However current versions cannot also perform the mask, which can be done prior (using an appropriate set of masks). Example 3 illustrates an example of x86 assembly code for a PCMM access. Again, two instructions are used. The first (line 10) computes the effective address (masking, shifting, and adding to the base). In the second instruction (line 13) the value is loaded from the computed address.

FIG. 9 illustrates compiler 130 processing source code 110 to generate runtime dynamically-updating pointer-compression. IR 140 is generated including dynamic updating instructions G1 915, G2 920, G3 925, and G4 930. As in the previous static example, the various types of instructions are distributed as necessary throughout. In this example, the source code 110 contains a function foo 910 which has j and k as arguments. Compiler 130 determines that an object or data structure with which foo 910 interacts is to be supported with dynamically updating pointer compression. A variable IndexLevel is set to the index size of the data structure. The index may change at runtime, as illustrated in one of the embodiments of 5A-5D, for example. When that happens, as described above, the G2 920 instructions are run to update the data structure in memory, and to set IndexLevel to the new index value. Function foo is replaced with a dynamically updating function foo 940, which takes IndexLevel as an argument (or alternately accessed as a variable) in addition to the source code arguments j and k. The compiler generates a series of foo functions 950, each tailored to operate with a supported index size. Here the example shows 4 supported pack levels and associated functions 950 including foo_x1, foo_x2, foo_x3, and foo_x4. At runtime, the IndexLevel parameter determines which foo function is executed. The function will include G3 and G4 instructions, as appropriate, to pack registers and access memory with the current index size. Thus, first function in source code is compiled into a second compression-enabled function which, responsive to an index level, selects one of a subseries of the function to operate pointer compression accesses using the index level.

A compiler, examples of which are described above, is a program that translates source code instructions for performing computational functions into machine code that can be executed by a computer, alternatively referred to as binaries, executable code, execution code, application code, etc. Some languages are not compiled but are rather interpreted. Interpretation differs from compilation in that the interpreter executes programs directly from source code without producing a standalone executable. The prior discussion focuses on compilers, but those of skill in the art will recognize compiling source code to an executable that is run on a computer can be substituted with a process of interpreting the source code while running on an interpreter.

Source code is typically written in a high-level programming language, which is designed to be easy to read and understand by developers. Intermediate representations and machine code are written in more compact and efficient lower-level languages. An intermediate representation generated from one form of source code can itself be a form of source code. The methods detailed herein can be applied to original source code or various levels of source code derived therefrom. A keyword from one form of source code may be transformed to or represented by a different keyword, numerical value, or token when processed into another form of source code or intermediate representation. A reference to a particular keyword in the methods, systems and devices described herein applies equally to any transformation or alternate representation.

Program execution generally takes place on computer hardware in a runtime environment. The computer hardware comprises processors, memory, and storage. The runtime environment is a set of software tools and resources that runs on the computer hardware to execute a program. The runtime environment includes the operating system, libraries, and other components that are necessary for the program to run. Computer hardware and runtime environments are well known to those of skill in the art.

FIG. 10 illustrates an example embodiment of distributed Integrated Development Environment (IDE) 1000 including components of a computational device, or user terminal, 100. Here user terminal 100 is connected via network 1040 with other user terminals 100a-n and a project server 1050. However, it should be noted that an IDE operating environment, a computational device 100, and the aspects disclosed herein are not constrained to any particular configuration of devices.

User terminals 100 may be any type of electronic device, such as, without limitation, a mobile device, a personal digital assistant, a mobile computing device, a smart phone, a cellular telephone, a handheld computer, a server, a server array or server farm, a web server, a network server, a blade server, an Internet server, a work station, a mini-computer, a mainframe computer, a supercomputer, a network appliance, a web appliance, an Internet-of-Things (IOT) device, a distributed computing system, multiprocessor systems, or combination thereof. A user terminal may be configured utilizing a cloud service. The operating environment of IDE 1000 may be configured in a network environment, a distributed environment, a multi-processor environment, or a stand-alone computing device having access to remote or local storage devices.

User terminals 100 may include one or more processors 1010, a communication interface 1012, one or more storage devices 1016, one or more input/output devices 1018, and a memory 150. A processor 1010 may be any commercially available or customized processor and may include multi-processor architectures. The communication interface 1012 facilitates wired or wireless communications between the computing devices such as user terminals 100, project server 1050, and other devices. The components of a user terminal 100 are communicatively coupled via one or more buses 1014.

A storage device 1016 may be a computer-readable medium that does not contain propagating signals, such as modulated data signals transmitted through a carrier wave. Examples of a storage device 1016 include without limitation RAM, ROM, EEPROM, flash memory or other memory technology, CD-ROM, digital versatile disks (DVD), or other optical storage, magnetic cassettes, magnetic tape, magnetic disk storage, all of which do not contain propagating signals, such as modulated data signals transmitted through a carrier wave. There may be multiple storage devices 1016 in the computing devices 100. The input/output devices 1018 may include a keyboard, mouse, pen, voice input device, touch input device, display, speakers, printers, etc., and any combination thereof.

A memory 150 may be any non-transitory computer-readable storage media that may store executable procedures, applications, and data. Various of these components and data are detailed above with respect to FIGS. 1, 4, and 6. The computer-readable storage media does not pertain to propagated signals, such as modulated data signals transmitted through a carrier wave. It may be any type of non-transitory memory device (e.g., random access memory, read-only memory, etc.), magnetic storage, volatile storage, non-volatile storage, optical storage, DVD, CD, floppy disk drive, etc., A memory 150 may also include one or more external storage devices or remotely located storage devices.

The memory 150 may contain instructions, components, and data. A component is a software program that performs a specific function and is otherwise known as a module, program, and/or application. The memory 150 may include an operating system 1030, one or more source code files 110, a compiler 130, executable code 160, and other applications and data 1036. Compiler 130 may include a lexical analyzer 610, a syntax analyzer 615, a semantic analyzer 620, an intermediate code generation module 625, a code optimization module 685, a code generation module 690, a Pointer Compression Memory Management (PCMM) processing module 120, and an intermediate representation 140.

User terminal 100 may utilize an IDE (details not shown) that allows a user (e.g., developer, programmer, designer, coder, etc.) to design, code, compile, test, run, edit, debug, or build a program, set of programs, web sites, web applications, and web services in a computer system. Software programs can include source code files 110, created in one or more source code languages (e.g., Visual Basic, Visual J #, C++. C#, J #, Java Script, APL, COBOL, Pascal, Eiffel, Haskell, ML, Oberon, Perl, Python, Scheme, Smalltalk and the like, as well as proprietary or custom-designed programming languages). The IDE may provide a native code development environment or may provide a managed code development that runs on a virtual machine or may provide a combination thereof. The IDE may provide a managed code development environment using a framework such as Java SE, .NET, Node.js, Python Frameworks such as Django, Flask, etc., Ruby on Rails, PHP Frameworks such as Laravel, Symfony, etc., React, and others. It should be noted that this operating environment embodiment is not constrained to providing the source code development services through an IDE and that other tools may be utilized instead, such as a stand-alone source code editor and the like.

Project server 1050 may be any type of electronic device, including without limitation those detailed for user terminals 100. A project server may be configured utilizing a cloud service.

The user terminals 100 and project server 1050 may be communicatively coupled via network 1040. The network 1040 may be configured as an ad hoc network, an intranet, an extranet, a Virtual Private Network (VPN), a Local Area Network (LAN), a Wireless LAN (WLAN), a Wide Area Network (WAN), a Wireless WAN (WWAN), a Metropolitan Network (MAN), the Internet, a portion of the Public Switched Telephone Network (PSTN), Plain Old Telephone Service (POTS) network, a wireless network, a WiFi® network, or any other type of network or combination of networks.

The network 1040 may employ a variety of wired and/or wireless communication protocols and/or technologies. Various generations of different communication protocols and/or technologies that may be employed by a network may include, without limitation, Global System for Mobile Communication (GSM), General Packet Radio Services (GPRS), Enhanced Data GSM Environment (EDGE), Code Division Multiple Access (CDMA), Wideband Code Division Multiple Access (W-CDMA), Code Division Multiple Access 2000, (CDMA-2000), High Speed Downlink Packet Access (HSDPA), Long Term Evolution (LTE), Universal Mobile Telecommunications System (UMTS), Evolution-Data Optimized (Ev-DO), Worldwide Interoperability for Microwave Access (WiMax), Time Division Multiple Access (TDMA), Orthogonal Frequency Division Multiplexing (OFDM), Ultra-Wide Band (UWB), Wireless Application Protocol (WAP), User Datagram Protocol (UDP), Transmission Control Protocol/Internet Protocol (TCP/IP), any portion of the Open Systems Interconnection (OSI) model protocols, Session Initiated Protocol/Real-Time Transport Protocol (SIP/RTP), Short Message Service (SMS), Multimedia Messaging Service (MMS), or any other communication protocols and/or technologies.

The foregoing description of the implementations of the present techniques and technologies has been presented for the purposes of illustration and description. This description is not intended to be exhaustive or to limit the present techniques and technologies to the precise form disclosed. Many modifications and variations are possible in light of the above teaching. It is intended that the scope of the present techniques and technologies are not limited by this detailed description. The present techniques and technologies may be embodied in other specific forms without departing from the spirit or essential characteristics thereof. The modules, routines, features, attributes, methodologies, and other aspects of the present disclosure can be implemented as software, hardware, firmware, or any combination of the three. Also, wherever a component, an example of which is a module, is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present techniques and technologies are in no way limited to implementation in any specific programming language, or for any specific operating system or environment. Accordingly, the disclosure of the present techniques and technologies is intended to be illustrative and not limiting. Therefore, the spirit and scope of the appended claims should not be limited to the foregoing description. In U.S. applications, only those claims specifically reciting “means for” or “step for” should be construed in the manner required under 35 U.S.C. § 112(f).

What is claimed is:

1. A method of compiling source code defining a collection with a plurality of elements to be instantiated in a memory at runtime, the method comprising:
determining an index size as the number of bits required to index each of the elements in the collection uniquely; and
generating instructions compilable to runtime instructions operable with a register to:
specify a mask of the index size;
specify a shift value responsive to an instruction to access an element of the collection;
select an index value stored in one of a plurality of segments of the register by masking with the mask and shifting according to the shift value; and
access the element of the collection in the memory using the selected index value.

2. The method of claim 1, wherein the index size is variable.

3. The method of claim 1, wherein the plurality of elements comprises a plurality of objects of a type.

4. The method of claim 1, further comprising generating instructions compilable to runtime instructions operable to:
instantiate the collection in memory, wherein each of the plurality of elements has an associated address in the memory;
instantiate a list of the associated addresses in the memory at a list memory address;
store the list memory address in a second register;
add the selected index value to the second register to produce a mapping address;
retrieve the associated address from the memory located at the mapping address; and
access the element of the collection at the retrieved associated address.

5. The method of claim 1, further comprising generating instructions compilable to runtime instructions operable to:
instantiate the collection in memory, wherein a first of the plurality of elements is stored at a first associated address and each additional element of the plurality of elements has an associated address in the memory that is an offset from the first associated address, each offset divisible by a scaling factor;
store the first associated address in a base address register;
multiply the selected index value by the scaling factor;
add the multiplied selected index value to the base address register to produce an element address; and
access the element of the collection at the element address.

6. The method of claim 1, further comprising generating instructions compilable to runtime instructions operable to:
monitor for an update to the collection;
determine whether the update increased the number of elements of the collection;
responsive to the number of elements of the collection increasing, compare the number of elements to the number of addressable elements indicated by the index size; and
increase the index size responsive to the number of elements being within a predetermined threshold of the number of addressable elements.

7. The method of claim 6, further comprising generating instructions compilable to runtime instructions operable to:
modify a mask size responsive to increasing the index size; and
modify a shift value responsive to increasing the index size.

8. The method of claim 1, further comprising generating instructions compilable to runtime instructions operable to:
monitor for an update to the collection;
determine whether the update decreased the number of elements of the collection;
responsive to the number of elements of the collection decreasing, compare the number of elements to a number of addressable elements indicated by a number of bits smaller than the index size; and
decrease the index size responsive to the number of elements being below a predetermined threshold of the number of addressable elements.

9. The method of claim 8, further comprising generating instructions compilable to runtime instructions operable to:
modify a mask size responsive to decreasing the index size; and
modify a shift value responsive to decreasing the index size.

10. The method of claim 1, further comprising, responsive to encountering an instruction in the source code to access a first of the plurality of elements, generating instructions compilable to runtime instructions operable to:
load an offset register with a plurality of offset values including a first offset value associated with the first of the plurality of elements and a second offset value associated with a second of the plurality of elements;
set an offset selector to select the first offset value; and
isolate the first offset value in the offset register responsive to the offset selector.

11. The method of claim 10, further comprising generating instructions compilable to runtime instructions operable to:
add the isolated offset to a base address to produce a lookup table address;
retrieve an element address from a memory at a memory location identified by the lookup table address; and
access the first of the plurality of elements from the memory at a memory location identified by the element address.

12. The method of claim 10, further comprising, generating instructions compilable to runtime instructions operable to:
scale the isolated offset by a scaling factor;
add the scaled isolated offset to a base address to produce an element address; and
access the first of the plurality of elements from the memory at a memory location identified by the element address.

13. The method of claim 1, further comprising, responsive to encountering in the source code a first access instruction to access a first element of the collection and a second access instruction to access a second element of the collection:
storing a first pointer offset associated with the first element in a variable at a first of a plurality of register locations, the first register location identified by a first offset selector value;
storing a second pointer offset associated with the second element in the variable at a second of the plurality of register locations, the second register location identified by a second offset selector value;
generating instructions compilable to runtime instructions operable to:
load the variable into a processor register; and
compute the first pointer offset using the first offset selector value; and
generating instructions compilable to runtime instructions operable to compute the second pointer offset using the second offset selector value.

14. The method of claim 13, further comprising:
scanning the source code to determine a size of the collection and the frequency of access to elements of the collection;
evaluating the collection for pointer-compression suitability based on the size of the collection exceeding a first predetermined threshold and the frequency of access exceeding a second predetermined threshold; and
performing the storing and compiling steps responsive to a suitable evaluation of the collection.

15. A method comprising:
instantiating in a memory a collection comprising a plurality of elements, the collection having a memory location associated with a base address, each of the plurality of elements having memory locations referenceable by one of a plurality of offsets from the base address;
determining a first index size as the number of bits required to index each of the collection elements uniquely;
loading a base register in a processor with the base address;
loading an offset register in the processor with a first packed value comprising a first plurality of concatenated pointers each having the first index size and each associated with one of the plurality of elements;
accessing the memory at an element address derived by extracting one of the concatenated pointers from the offset register and adding the extracted pointer to the base register;
modifying the collection;
determining whether the first index size is suitable to index each of the modified elements of the collection uniquely;
responsive to the first index size not being suitable, recomputing a second index size as the number of bits required to index each of the modified collection elements uniquely;
loading the offset register in the processor with a second packed value comprising a second plurality of concatenated pointers each having the second index size and each associated with one of the plurality of elements; and
accessing the memory at an element address derived by extracting one of the concatenated pointers from the offset register and adding the extracted pointer to the base register.

16. The method of claim 15, wherein the first index size and the second index size are variable.

17. The method of claim 15, further comprising, responsive to recomputing the second index size, reordering at least a portion of the collection in memory aligned to an updated scaling factor, and generating the second packed value based on the reordered memory.

18. The method of claim 17, wherein reordering the collection comprises grouping smaller elements to lower addresses and larger elements to higher addresses to reduce unit addressable space for direct access.

19. The method of claim 15, further comprising performing parallel access to corresponding elements of the first-mentioned collection and a second collection by:
loading a first base register with a base address of the first-mentioned collection;
loading a second base register with a base address of the second collection;
loading a common offset register with a packed value of offsets; and
selecting an offset from the common offset register using a common selector to access corresponding elements in both collections concurrently.

20. The method of claim 15, further comprising updating at least one of a mask and a shift value used to extract concatenated pointers from the offset register responsive to changing the index size or an applied scaling factor.

21. A system comprising:
one or more processors;
a memory coupled to the one or more processors; and
one or more programs stored in the memory and configured to be executed by the one or more processors, the one or more programs including program instructions operable to:
instantiate in the memory a collection comprising a plurality of elements, the collection having a memory location associated with a base address, each of the plurality of elements having memory locations referenceable by one of a plurality of offsets from the base address;
determine a first index size as a number of bits required to index each of the collection elements uniquely;
load a base register with the base address;
load an offset register with a first packed value comprising a first plurality of concatenated pointers, each having the first index size and associated with one of the plurality of elements;
access the memory at an element address derived by extracting one of the concatenated pointers from the offset register and adding the extracted pointer to the base register;
modify the collection;
determine whether the first index size is suitable to index each of the modified collection elements uniquely;
responsive to the first index size not being suitable, recompute a second index size as the number of bits required to index each of the modified collection elements uniquely;
load the offset register with a second packed value comprising a second plurality of concatenated pointers each having the second index size and associated with one of the plurality of elements; and
access the memory at an element address derived by extracting one of the concatenated pointers from the offset register and adding the extracted pointer to the base register.

22. The system of claim 21, wherein the one or more programs are further operable to, responsive to recomputing the second index size, update at least one of a mask and a shift value used to extract the concatenated pointers from the offset register.
